(19) United States
(12) Patent Application Publication
(10) Pub. No.: US 2019/0304026 A1
(43) Pub. Date: Oct. 3, 2019

(54) PROPERTY INVESTIGATION SYSTEM AND METHOD

(71) Applicant: Betterview Marketplace, Inc., San Francisco, CA (US)

(72) Inventors: David Dwight Lyman, San Francisco, CA (US); David Jerome Tobias, San Mateo, CA (US); Jason Renwick Janofsky, San Marcos, CA (US); Matthew Tyler Preston, Oakland, CA (US); Taylor Caitlyn Dohmeier, San Francisco, CA (US)

(21) Appl. No.: 16/367,153

(22) Filed: Mar. 27, 2019

Related U.S. Application Data
(60) Provisional application No. 62/806,628, filed on Feb. 15, 2019.
(60) Provisional application No. 62/649,347, filed on Mar. 28, 2018.

(51) Int. Cl. G06Q 40/08; G06N 20/00; G06Q 50/16; G06K 9/00; G06K 9/62

(52) U.S. Cl. CPC G06Q 40/08; G06N 20/00; G06K 9/6262; G06K 9/00671; G06Q 50/165

(57) ABSTRACT

A structure evaluation system is disclosed. In one implementation, an image of the structure is obtained. The image is analyzed. An annotation is generated for the image for a plurality of specific attributes predictive of a loss risk. The annotation may include a set of fields for the specific attributes. In one example, a trained machine learning model is used to generate the specific attributes. The annotations are aggregated to form a signal indicative of a loss risk. In one example, the signal is a score. In some examples, a recommendation is generated for monitoring or remediating the loss risk.

### CROSS-REFERENCE TO RELATED APPLICATIONS

This application claims the benefit under 35 U.S.C. § 119(e) of U.S. Provisional Patent Application No. 62/806,628, entitled “User Interface For Property Investigation System And Method” and filed Feb. 15, 2019, and U.S. Provisional Patent Application No. 62/649,347, entitled “Property Investigation System and Method” and filed Mar. 28, 2018, each of which are incorporated herein by reference in their entirety.

### TECHNICAL FIELD

Embodiments of the present disclosure are generally related to generating property investigations indicative of potential damage, hazards, or other risks to a building structure on a property.

### BACKGROUND

There are a variety of businesses that utilize property investigations, such as construction, insurance, banking, finance, and real estate. However, there are many problems with conventional approaches to property investigation. For example, traditionally on-site investigation by a field agent is performed in which a field agent performs an onsite visual assessment of building structures, such as assessing the condition of a roof. However, this approach has technical limitations on the quantity, quality, and consistency of data that it provides. Additionally, there are other technical limitations on the ability for entities to effectively use the assessment data. Embodiments of this disclosure were developed in view of some of the problems and shortcomings of the prior art.

### SUMMARY

Techniques to evaluate building structures on a property are disclosed. In one implementation, a method of evaluation includes accessing an image of a property structure; analyzing the image to generate a plurality of attributes predictive of a loss risk for the property structure; and forming, based on an aggregation of the plurality of attributes predictive of a loss risk, a signal indicative of a loss risk for the property structure. The image analysis is performed in some embodiments using an artificial intelligence engine alone and in combination with human evaluators in some embodiments. In one implementation, an annotation is generated for the image that includes fields that are filled out for each of the plurality of attributes. In one embodiment, the signal comprises a numerical or graded score for the loss risk. In one embodiment, the signal comprises a recommendation for the loss risk.

In some embodiments, the signal is utilized to generate a roof score indicative of the loss risk for the roof based on an aggregation of a plurality of roof risk attributes predictive of a loss risk for the roof.

### BRIEF DESCRIPTION OF THE DRAWINGS

FIG. 1 is a high-level block diagram of a property investigation system in accordance with an embodiment.

FIG. 2 is a flow chart of a method of generating property reports and recommendations in accordance with an embodiment.

FIG. 3 is a flow chart of aspects of data accesses used to generate property reports in accordance with an embodiment.

FIG. 4 is a flow chart of a method of training an AI engine to perform a property investigation in accordance with an embodiment.

FIG. 5 is a flow chart of a method of generating property profile reports and recommendations in accordance with an embodiment.

FIG. 6 is an example of a computer system implementing the property investigation system in accordance with an embodiment.

FIG. 7A is a flow chart of a method of generating a roof score in accordance with an embodiment.

FIG. 7B is a flow chart illustrating a method of user customization of aspects of the property investigation in accordance with an embodiment.

FIG. 8 illustrates a method of obtaining property boundary and structure footprint information in accordance with an embodiment.

FIG. 9 illustrates a method of selecting imagery data for use in a property investigation in accordance with an embodiment.

FIG. 10A illustrates aspects of quality assurance in accordance with an embodiment.

FIG. 10B illustrates an example of quality assurance that includes a consensus logic in accordance with an embodiment.

FIG. 11 illustrates a method of generating a roof score in accordance with an embodiment.

FIG. 12 illustrates an example of tiers of roof risk for a set of roof risk factors and associated scorings in accordance with an embodiment.

FIG. 13 illustrates a method of suggesting default recommendations to improve recommended actions within an organization in accordance with an embodiment.

FIG. 14 illustrates a method of partially or completely automating recommendation letters, based on priority levels, in accordance with an embodiment.

FIG. 15 illustrates an example of a user interface displaying a roof score and other benchmark scores in accordance with an embodiment.

FIG. 16 illustrates user customization of priority levels and displays of information about risks and risk factors in accordance with an embodiment.

FIG. 17 illustrates a user selection of detection type in accordance with an embodiment.

FIG. 18 illustrates an example of a property profile showing labelling/tagging of roof materials of a building structure on a property in accordance with an embodiment.

FIG. 19 illustrates an example of an action plan providing a suggested list of actions for monitoring or remediating roof risks in accordance with an embodiment.

FIG. 20 illustrates an example in which the action plan includes priority levels for monitoring or remediating a variety of different roof risk factors in accordance with an embodiment.

FIG. 21 illustrates an example of property profile including a low roof score associated with roof damage in accordance with an embodiment.

FIG. 22 illustrates an example of a property profile and user creation of an action plan for roof damage and moderate rust in accordance with an embodiment.

FIG. 23 illustrates an example in which a set of default actions are provided in a user interface to address detected risk factors in accordance with an embodiment.

FIG. 24 illustrates user-selection of a particular action in accordance with an embodiment.

FIGS. 25, 26, and 27 illustrate in more detail aspects of a user interface to select an action plan and record comments in accordance with an embodiment.

FIGS. 28, 29, and 30 illustrate an example of a user interface in which damaged roof measurements are displayed in accordance with an embodiment.

FIG. 31 illustrates an example in which a user interface shows benchmarks, factors negatively influencing scores, factors improving scores, and factors not directly impacting individual scores in accordance with an embodiment.

FIG. 32 illustrates an example showing a common peril in a region and roof factors making the roof more prone to the peril.

FIG. 33 illustrates another example showing a common peril in a region and roof factors making the roof more prone to the peril.

### DETAILED DESCRIPTION

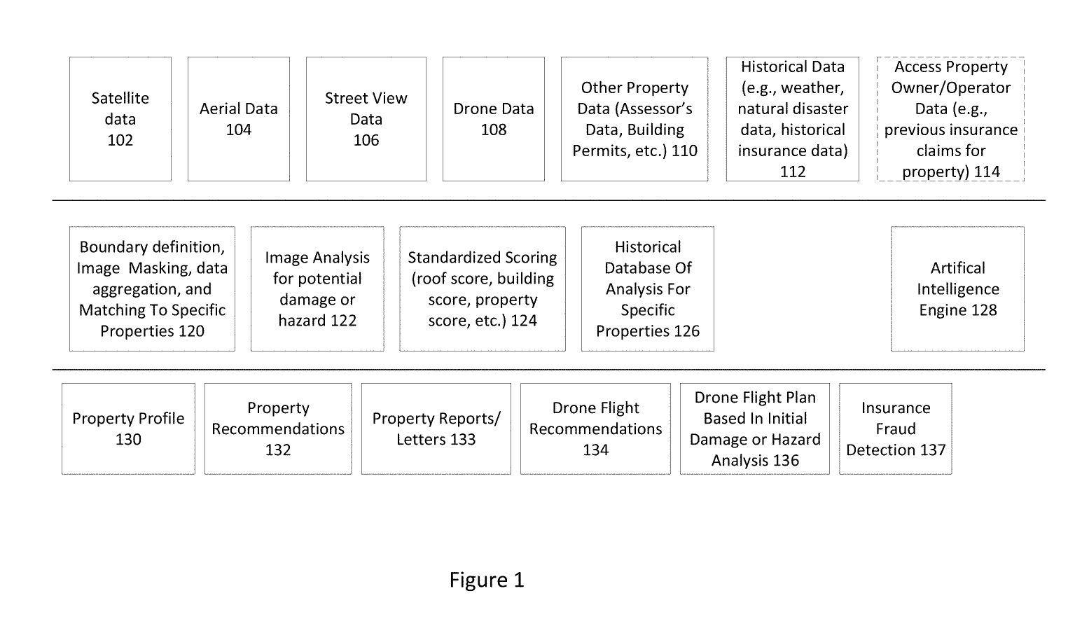

FIG. 1 is a high-level block diagram of a computer system in accordance with an embodiment. A set of illustrative functional blocks are illustrated, which may be implemented in hardware, software, or firmware, depending on the functional block at issue and on implementation details as described below in more detail. Additionally, as described below in more detail, other components would be understood to be included to support the computer system. In one embodiment, the computer system generates information to evaluate structures on a property, such as a building structure, although more generally it may include other structures on the property, such as a swimming pool.

In the top row of FIG. 1, different types of property imaging data are accessed via data interfaces. This includes satellite imaging data 102 and aerial imaging data 104. Street view data 106 (when available) may also be accessed. Drone imaging data 108 is another optional source of imaging data. Other sources of data for a particular property 110 may be accessed, such as property assessor's data, building permits, etc. Data 112 on historical weather data, natural disaster data, or historical insurance data may be accessed to provide data regarding general information of the region a property is located in. For example, historical weather data may include data on storms that are likely to cause property damage to roofs or other portions of a building. Natural disaster data may, for example, include historical data on wildfires or flooding. When available, information on insurance claims in a general geographic area that the property resides in may be an indicator of historical natural disasters in a particular geographic area. Another potential optional source of information is information on a property owner 114 related to a property. For example, information on previous insurance claims, if available, may be useful in some situations to determine if a roof or other portion of a building has been previously damaged or repaired.

In the middle row, additional processing is performed on the data sets. In one embodiment, processing is performed in block 120 to match data sets to a particular property. This may include boundary definition, masking, and data aggregation. For example, the boundaries of a particular property may be identified, the different types of data mapped to the same boundaries, and the imaging data limited to a particular property or a particular building on a property. In block 122, image analysis is performed for a particular property. This can include an analysis for particular types of hazards and risks. In one embodiment, image analysis is performed to determine a roof type (e.g., shape of roof and roofing material). The imaging data is then analyzed for one or more types of potential damage or hazards, such as hail damage, rust on ventilation shaft or other metal sections, standing water on the roof, and rain gutter conditions. This may include an assessment of a likely damage type and likely damage severity. Other types of damage and risk assessment may be performed, including analyzing structural deterioration of fences.

Time based analysis may also be performed to compare sequences of images of a given property over time.

In one embodiment, the system generates a property loss risk signal. The signal may be in the form of a score, although more generally the signal can take other forms. The score may, for example, be a numeric score or a grade. In one embodiment, in block 124 a standardized scoring is performed. This may include a standardized roof score, building score, or other property score. For example, a roof may be assigned a letter grade of A, B, C, D, or F to indicate its general condition. Alternately, a numerical score, a color code, grouping, bucketing, or other grading nomenclature may be used. In one embodiment, the grading system provides a grade useful for a general risk assessment or damage assessment.

In block 126, a historical database of analysis is formed for training an Artificial Intelligence (AI) engine 128. The AI engine may, for example, utilize a machine learning model that is trained to generate a trained machine learning model. For example, a proprietary database of analyzed and tagged images of buildings and properties may be used as training data to train the AI engine. An initial training process may be performed. Additionally, ongoing data may be used to improve the results of the machine learning model. That is, the historical database is collected over time and used as training data to train an AI engine to perform image analysis, such as damage assessment, risk assessment, and scoring. It will be understood throughout the following discussion that a variety of machine learning techniques may be used to implement the AI engine, including, for example, neural networks, supervised learning, unsupervised learning, and semi-supervised learning.

In one embodiment, a graphical user interface and dashboards provide a variety of different information. In block 130, a property profile is generated and property recommendations may be generated in block 132. In one embodiment, satellite data and aerial data is used to generate a preliminary property assessment using AI to process the image data. A quick grade may be provided in the report, where the grade may be based on a standardized protocol, which may be based on a weighted set of variables. For example, a roof may be given a grade and a description of the roof shape, roofing material, etc. The grade may be based on a standardized protocol so that a common grading system can be applied to many different properties. As illustrative examples, the grade could be a letter grade or a numerical score (analogous to a FICO score).

Historical weather data for the property may be displayed. An analysis of critical issues, priority issues, and moderate issues may be provided. An assessment of roof condition may be provided such as below average, average, or above average. Report details may include more detailed analysis, concerns, and action items. Specific forms of damage may be identified. In one embodiment, a user can toggle between an aerial view, a satellite view, and a street view of a property over a range of historical dates.

In one embodiment, an initial property profile is performed using aerial data, street view data, and satellite data but without drone data. The initial property profile may be used to identify signs of damage or risks at a coarse level of detail based on the resolution of aerial data and street view data along with historical data and other data. This information may be used to generate recommendations on a potential value of performing a drone flight or sending a building inspector, claims adjuster, roofer, surveyor, engineer, or other professional for more detailed analysis, as indicated in block 134 and suggesting aspects of a drone flight plan as indicated in block 136. For example, an initial assessment using aerial data may be used to determine regions of a building a drone is to capture images, a minimum number of high resolution images in particular regions, etc.

A variety of property reports 133 may be generated, including report letters for insurance companies, underwriters, or other entities. An additional option is to use historical data to generate information on potential fraud as indicated by block 137. For example, historical aerial data, street view data, and other data may be used in some cases to compare a particular damage claim (e.g., hail damage claim) against the historical condition of a roof.

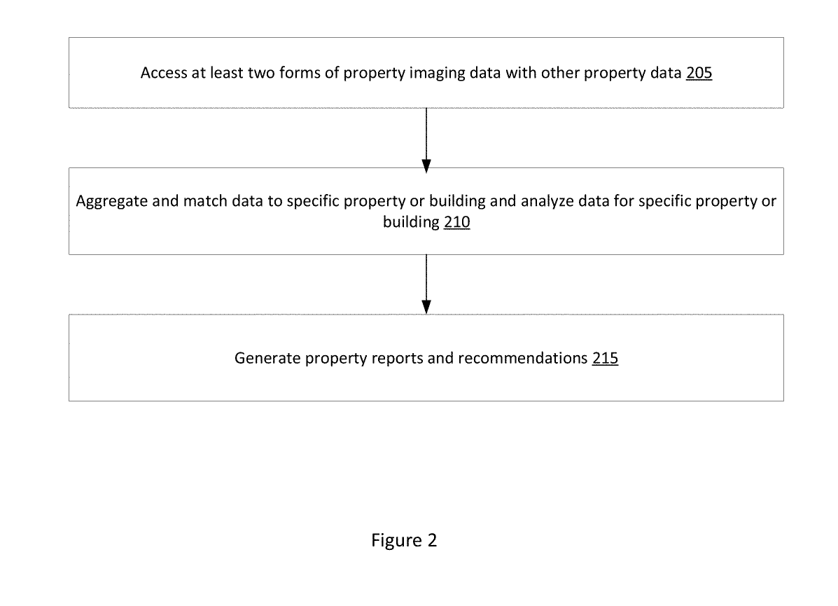

FIG. 2 illustrates a general method in accordance with an embodiment. In block 205, at least two forms of property imaging data are accessed along with other property data. This may include for example, accessing satellite data, aerial data and street view data for a property along with historical data for the property or the region the property is located in, such as historical weather data or natural disaster data. In some use cases, drone data may be included. In other cases, drone data is not included, such as for forming a preliminary assessment of a property. In block 210 the data sets are aggregated and matched to a specific property or building and analyzed, where the analysis may be performed at least in part using AI of image data. In block 215, property reports and recommendations are generated, which may include standardized scores or grades.

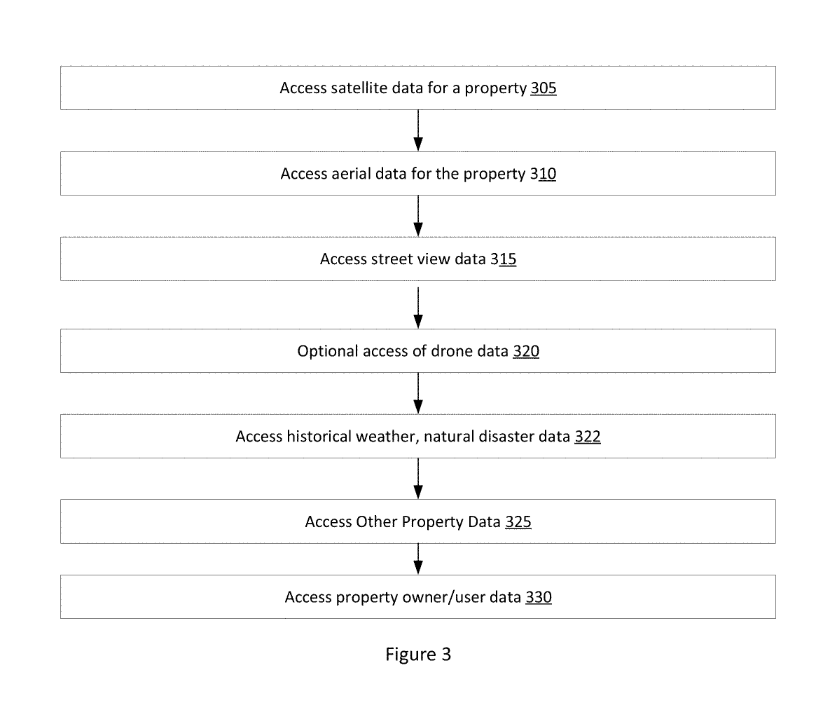

FIG. 3 illustrates a general method of accessing different property data sources for generating a property profile, property report, or property recommendation. A selection is made of different data sources. Satellite data 305 is available from a variety of sources but has limited resolution. Aerial data 310 is available from a variety of services and has better resolution than satellite data. Street view data 315 is available from Google for many properties. In some cases, historical drone data is available and may be accessed 320, such if a property was previously studied. Alternately, a drone flight could be custom ordered for a property. Historical data 322 is accessed, such as weather data or natural disaster data. However, the selection of a particular type of historical data may depend on the objective of a profile or a report. Historical weather data may be particularly important for certain types of roof damage. However, to assess fire hazards historical data on wildfires in a geographic region may be important. The accessing of other property data 325 may also depend on the goals of a property profile or report. For example, assessor's data or building permits may not be useful to determine a condition of grounds that may increase a fire risk. Also selecting property owner data may also depend on the goals of a property profile or report, as well as the availability of such data.

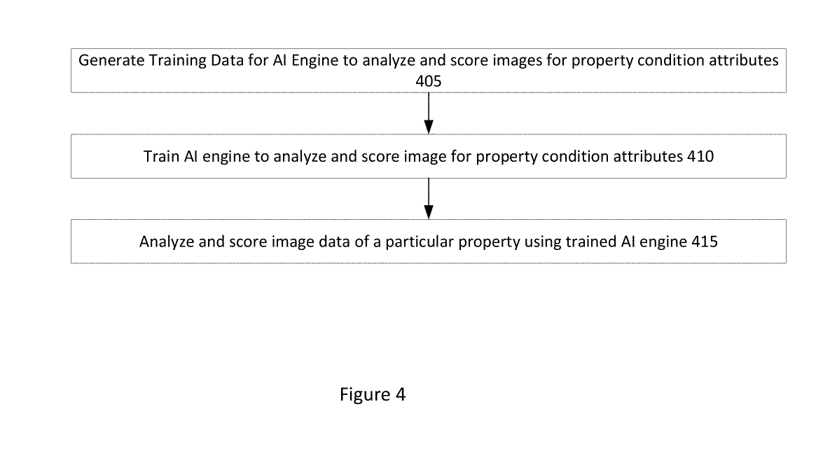

As illustrated in the flow chart of FIG. 4, in one embodiment training data is generated in block 405 to train an AI engine to analyze and score images for property condition attributes. The property conditions attributes may, for example, include indications of roof shape, roofing material, roof damage, roof condition, etc. For the case of a roof, the AI engine may be trained to identify features in images that are likely to be signs of a particular type of damage, such as hail damage, and score the damage. For example, for hail damage an estimate of a size, shape, and number of likely hail impact features may be generated through an AI engine trained to analyze roof features in images indicative of hail damage. The AI engine is trained in block 410 to analyze and score selected property attributes. In block 415, image data and other data for a particular property is analyzed using the trained AI engine.

In one implementation, an image is obtained and then it is analyzed. A set of attributes predictive of a loss risk is determined. For example, an annotation for an image may include a set of fields for specific attributes of risk factors. In the case of a hail risk, a plurality of individual attributes of a structure may be predictive of a loss risk. The set of attributes in the annotation for an image is aggregated to form a signal indicative of a loss risk. For example, all of the different specific attributes may be taken into account as factors contributing to a loss risk. The signal indicative of a loss risk may include a User Interface field, a score, or a recommendation as a non-limiting list of examples. While a trained machine learning model in the AI engine may perform all of the analysis, more generally at least some of the analysis may also be performed by human evaluators.

The AI engine may also be trained to assist in preparing at least some of the documentation provided to end users. For example, the AI engine may also be trained to generate standardized scores or grades and at least some portions of property profiles, property reports, property recommendations, and drone flight recommendations.

In one embodiment, the grades are based on weighted scores. In one embodiment, a roof score is generated based on a weighted score. For example, an algorithm may determine a most likely roof shape profile based on AI analysis of image data. AI analysis may be used to determine the most likely material for the roof. In one embodiment, the AI image analysis also analyzes tree overhang of the roof and generates a score. In one embodiment, the AI analysis determines the presence and severity of water ponding and gives that a score. This can be continued for multiple factors, including AI analysis of rust, hail damage, storm damage, etc. A weighted score can be generated from a combination of scores.

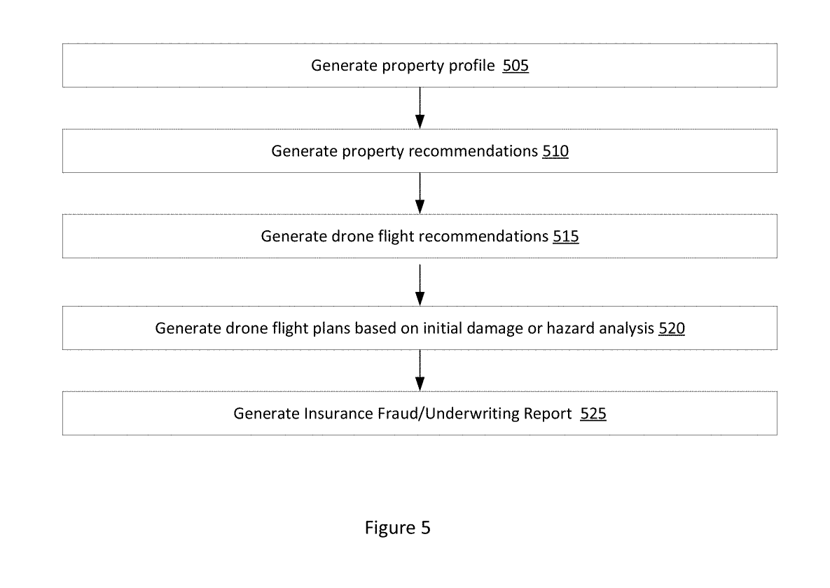

FIG. 5 illustrates an example flow chart of property investigation outputs in one embodiment. Generally speaking, a variety of different user dashboards, user interfaces, and outputs could be provided depending on the objective of property profile objectives. However, as one potential use scenario, customers might start with a basic property profile report and follow up with a selection of other services. In block 505, a property profile 505 is generated. This may or may not also include recommendations 510 or suggested action items. For example, a roof could be given a low grade with recommendation that there was a high risk and suggesting roof repairs or replacement be considered. Drone flight recommendations 515 may be generated. This may include a portion of a profile or report indicating whether a preliminary assessment indicates a potential property concern that might warrant a drone inspection. If a drone flight is selected, a drone flight plan may be generated based on an initial damage or hazard analysis 520. An insurance or underwriting report may be generated 525. More generally, other types of reports may be generated.

In some embodiments, changes to a roof or property are determined by the AI engine. For example, a roof or portion of a building may be damaged or destroyed by a storm. In extreme conditions (e.g., a tornado or extreme hurricane) an entire roof or property may be destroyed. Additionally, in some situations a roof or building may be modified. For example, a building may be modified to include a new room or rooms or a roof style or roof material type may be modified. Change detection may be implemented by, for example, training the AI engine to recognize a variety of different types of changes to buildings/roofs.

In some embodiments, change analysis may be performed on an individual property over an extended period of time. For example, new data may be gathered and scored for an individual property. This may be performed continually (in response to new data becoming available), on a periodic basis (e.g., once a year), on a scheduled basis (e.g., based on various needs or considerations, such as the needs of an insurance company), in response to a risk consideration (e.g., hurricane season), or by some other scheduling system that takes into account the availability of new data and a desire to detect changes to an individual property in selected time periods or for selected risk conditions. The old and new scores may be compared to determine if anything has changed with a property. For example, updates to satellite image data, aerial data, or street view data may be detected. Updates to other sources of data (e.g., assessors' data) may also be detected for a property. Thus, depending on implementation details, the change analysis may be performed comparing a roof or a property between at least two different time periods.

More generally, the change analysis may be performed over a sequence of time periods when new or updated data is available. For example, in some situations it may be useful to perform a change analysis of a roof or a building over a sequence of time periods to detect changes associated with, for example, a sequence of storms.

In yet other implementations, the change analysis may be simulated using past information, current information and future projected information. For example, with the current condition of a roof, the damage caused by a storm two years ago, and a projection of a similar storm for one month from the current date, can be used as input to the system, and the system will generate a predicted change analysis based on that input. More specifically, the grade/score for a roof at a given point in time can be simulated. For instance, if a user wants to know what the grade/score would have been on Jul. 4, 2017, the system will retrieve weather data as of that date and going backward. The system would also take the most recent imagery before that date (i.e., it could be Jun. 2, 2017). Then the system can generate a grade/score that should be an estimate of what a score should have been on Jul. 4, 2017. This generated score can be compared to current conditions or used in other ways by the algorithm s of the system. For example, the difference between this simulated score and the actual score can be used to determine critical factors and weight them accordingly for improved accuracy.

In some embodiments, scoring data may be compared between time periods to detect changes to a roof condition or a property condition. For example, scoring of image data may be compared in different time periods to detect changes to a roof, including but not limited to, damage, deterioration, repairs, or replacement. In addition, any detected change may be used as a trigger to generate notifications, warnings email messages, etc. In some cases, the change may need to satisfy a threshold in order for a notification or warning to be generated and sent. The notifications may be generated and sent in the application but may also be provided by a server via email or via an API.

In some embodiments, additional analysis of scoring data compared between times can be used for deriving other insights from the images. In addition to the scoring/grading described above, the analysis of scoring data may also be used to detect the existence of other conditions including but not limited to repair, new construction/additions, replacement, destruction, removal, etc. Specifically, the system can do additional processing of the imagery data and scoring to determine that a building has been added to a property, destroyed, has been modified (expanded or reduced in size). If a roof has been replaced or repaired, the fact that it happened and approximately when it happened can be determined from the data and stored, for example, in a database for later use. This information, for example when the roof was added, allows the system to augment the image data and determine a roof age or the timing of a major repair if it happened during the time over which the system has historical imagery. The system can detect changes in vegetation and other property attributes like a new swimming pool, BBQ grill, trampoline, pavement, etc. These additional insights can have individual data, attributes and uses, and the one set forth above in this paragraph are merely a few examples of what additional insights the system may provide in terms of condition, change and value.

Embodiments of this application may be used after natural catastrophes, such as hurricanes, tornadoes, fires, mudslides, hail storms, or flood to analyze buildings/roofs of individual homes in a disaster area. Additionally, an analysis may also include an analysis of a neighborhood or a community in a disaster area.

In some embodiments, insurance claims data may be used to improve a scoring model used to determine a roof or building score. For example, suppose a claim to replace a roof after a wind storm is at a cost of $21,000. This insurance claim data, and the insurance claims data for other comparable roofs damaged in the same wind storm or in comparable wind storms, may be used as an additional source of data to refine a scoring model. For example, the scoring or grading of roof damage may be improved in some embodiments based on using the claims data as an additional source of information to refine the scoring models.

Embodiments of the present disclosure may be practicing using a computing system or server that is adapted to support image analysis from different image sources and historical data sources as well as analyze images using AI.

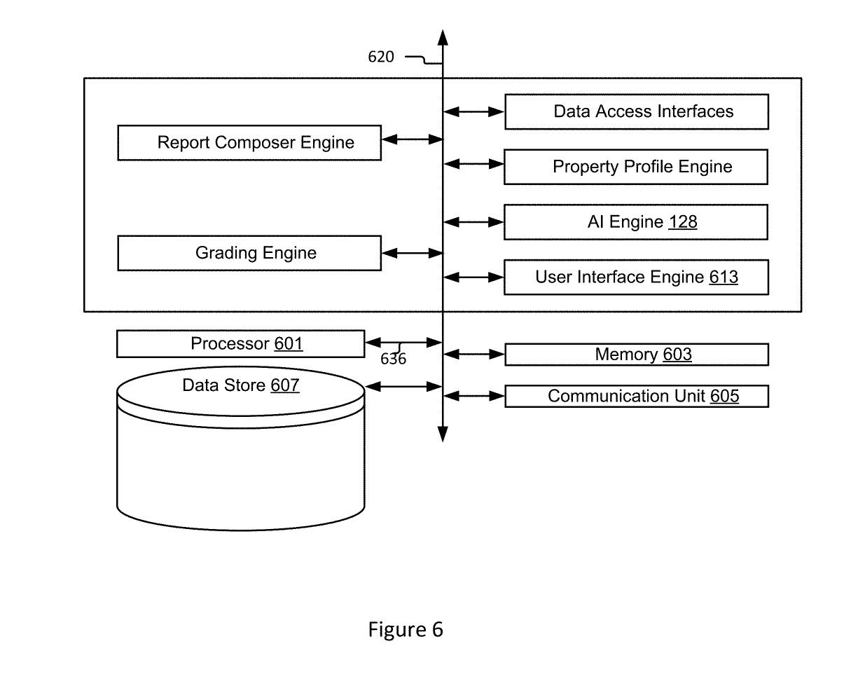

FIG. 6A is a block diagram of a computer system or server to implement the previously described methods. The computer system or server may include an interface to an input device (not shown) or user interface (not shown). The computer system or server may be configured to provide any of the previously described functions and methods as a web-based or cloud-based service in which customers request information on a specific property and receive a graphical user interface having dashboards or other user interface features to generate displays of property profiles, property reports, etc. The components of the system may be implemented in a computer system or server that includes hardware, software, and/or firmware. The computer code may be stored in a memory 603 and is accessible and executable by the processor 601. A signal line 620 may be provided for different components to communicate with each other and with a data store 607, communication unit (e.g., a network interface). In some embodiments, individual components may be implemented as modules including data access interfaces, a property profile engine, an AI engine, a user interface engine, a grading engine, and a report composer engine.

The AI engine 128 includes hardware, software, and/or firmware that facilitate automated, continuous analysis and correlation of fed data. In some embodiments, the AI engine 128 may include a set of instructions executable by the processor 601 to provide the functionality described above, such as implementing a trained machine learning model. In some embodiments, the AI engine 128 may be stored in the memory and is accessible and executable by the processor 601.

A report engine may be included for generating reports. A profile engine may be provided to generate property profiles. A grading engine may be included if grading is not otherwise implemented by the AI engine. For example, the grading engine could utilize a standardized protocol that receives inputs, such as input scores from an AI engine, such as a number and size of features likely to be hail damage on a roof. The report engine, profile engine, and grading engine may be implemented as computer program instructions on a storage device. Hardware, software, or firmware support may also be provided to access specific sources of image data, historical data, and other forms of data.

The user interface engine 613 is software including routines for generating a user interface in response to instructions received from other components. In some embodiments, the user interface engine 613 is a set of instructions executable by the processor 601.

In one embodiment, the processor 601 comprises an arithmetic logic unit, a microprocessor, a general-purpose controller or some other processor array to perform computations and provide electronic display signals to a display device. The processor 601 may be coupled to the bus 620 for communication with the other components via a signal line. The processor processes data signals and may comprise various computing architectures including a complex instruction set computer (CISC) architecture, a reduced instruction set computer (RISC) architecture, or an architecture implementing a combination of instruction sets. Although only a single processor is shown, multiple processors may be included. The processing capability might be enough to perform complex tasks, including various types of feature extraction and matching. It will be obvious to one skilled in the art that other processors, operating systems, sensors, displays and physical configurations are possible.

In one embodiment, memory 603 stores instructions and/or data that may be executed by processor 601. The instructions and/or data may comprise code for performing any and/or all of the techniques described herein. The memory may be a dynamic random-access memory (DRAM) device, a static random-access memory (SRAM) device, flash memory or some other memory device known in the art. In some embodiments, the memory also includes a non-volatile memory or similar permanent storage device and media such as a hard disk drive, a floppy disk drive, a CD ROM device, a DVD ROM device, a DVD RAM device, a DVD RW device, a flash memory device, or some other mass storage device known in the art for storing information on a more permanent basis.

The communication unit 605 transmits and receives data. For example, the communication unit 605 may include a USB, SD, CAT-5 or similar port for wired communication. In some embodiments, the communication unit 605 includes a wireless transceiver for exchanging data with a third-party server using one or more wireless communication methods, such as IEEE 802.11, IEEE 802.16, BLUETOOTH® or another suitable wireless communication method.

In some embodiments, the communication unit 605 also provides other conventional connections to the network for distribution of files and/or media objects using standard network protocols such as TCP/IP, HTTP, HTTPS and SMTP as will be understood to those skilled in the art.

The data store 607 is an information source for storing and providing access to data and may be coupled via the bus 620 to receive and provide access to data.

The disclosed technologies may also relate to an apparatus for performing the operations herein. This apparatus may be specially constructed for the required purposes, or it may include a general-purpose computer selectively activated or reconfigured by a computer program stored in the computer.

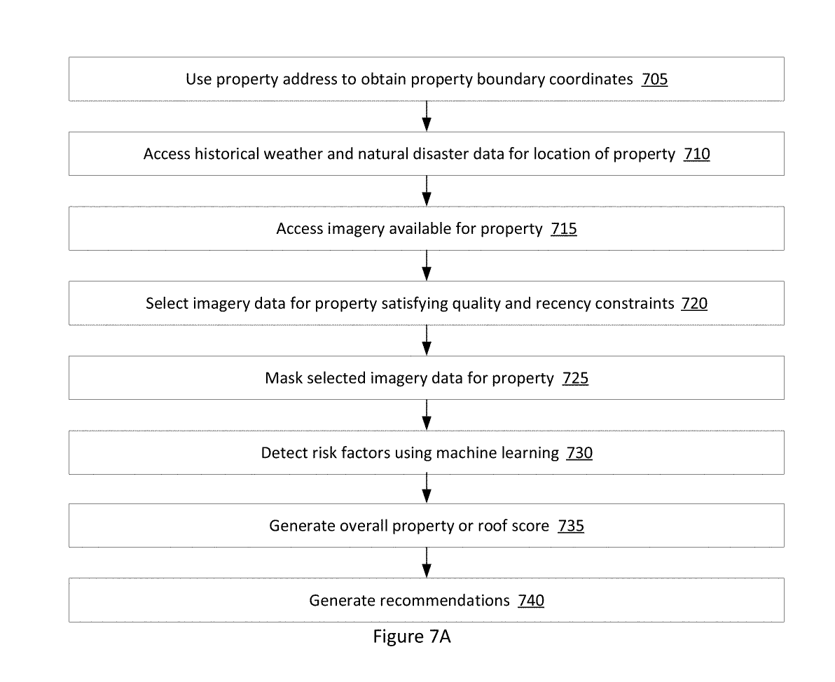

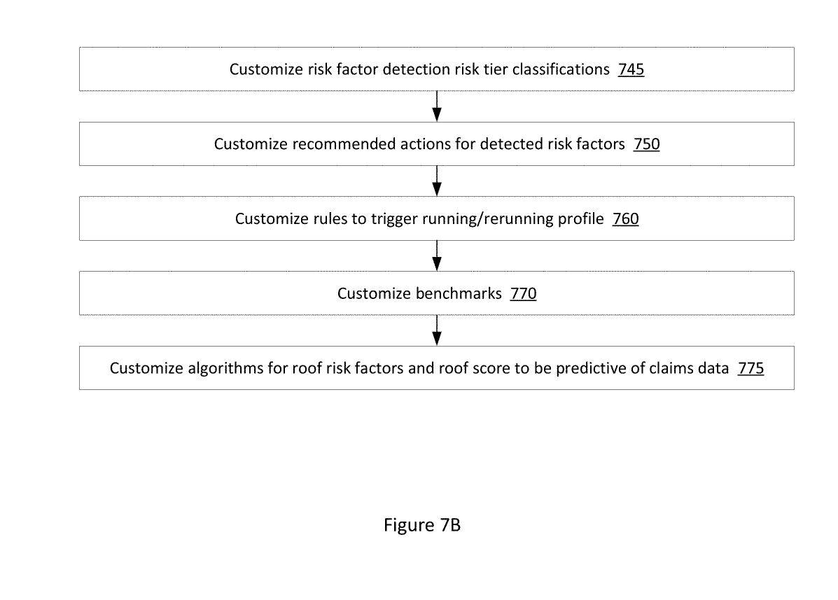

FIG. 7A is a flow chart illustrating a method of generating a property profile from imagery data in accordance with an embodiment. In block 705, the address of a property is used to obtain property boundary coordinates, such as precise latitude/longitude coordinates for the property. Footprint information for the property and for the building structures on the property may be obtained, either directly from some sources or from other historical databases, such as from assessors' offices or other databases. From this, the property boundary and a building footprint may be determined. In block 710, historical weather data is obtained for the property based on the geographical coordinates of the property, such as by accessing weather databases to identify weather related risks, such as data on windstorm risks, hail risks, etc. This may include, for example, a frequency and severity of extreme weather events. Optionally, other natural disaster risks may be obtained for the property based on the geographical coordinates, such as historical earthquake, wildfire, flood, or other natural disaster risks. That is, information on various perils may be collected, including their historical frequency and severity.

In block 715, the geographical coordinates are used to access imagery data, such as satellite imagery data and aircraft imagery data. In particular, some vendors of imagery data permit a tile of image data to be purchased but then a decision needs to be made as what portion of the imagery data corresponds to a particular property. In block 720, a selection made from imagery data is available for the property subject to any selected constraints on image quality and recency. For example, for an insurance policy underwriter, a relevant time period may be a selected time range. Quality constraints related to aspects of image quality necessary to perform a set of selected visual detections.

For example, an individual satellite image may have lower-than-average quality due to local cloud cover and thus needs to be rejected. Some imagery data, such as aircraft imagery data, may have been collected too far in the past to be relevant to a particular property profile task (e.g., checking for potential risks or damage after a recent hurricane event).

In block 725, the boundary information for the property is used to mask selected imagery data for the property and building structures on the property. In some cases, this may be a single image for a single date, although more generally the analysis may be performed over a number of images from different dates within the recency range.

In block 730, the masked imagery data is run through machine learning models to detect for attributes of property risk factors. Each property risk factor may, for example, correspond to a property loss risk. In one embodiment, the property risk factors include roof risk factors. Each property risk factor may be generated as a signal for internal use, external display, or for a combination of internal use and external display, depending on implementation details. A property risk factor can be a yes/no detection, such as detecting the presence of a swimming pool or a trampoline on a property from attributes such as shape, color, texture, etc. More generally the attributes can be relative, such as detecting a degree of granule loss in roofing material.

For some risk factors, such as tree overhang over a roof, the risk can be classified into tiers of risk, such as a high degree of overhang of trees over the roof, a medium degree of overhang, or low overhang.

In one embodiment, the method generates a property loss risk signal, which in some implementation is in the form of a numerical score or a grade. In block 735, the detected property risk factors are used to generate an overall property risk score or grade. For example, for a roof score, all of the roof risk factors scores may be used together to generate an overall roof score or grade (e.g., “A”, “B”, “C”, “D”). For example a weighted sum of individual roof risk factors may be calculated. Additionally, points may be assigned for a frequency and severity of historically extreme weather events or natural disasters. For example, if the property is located in a location with a history of high wind events, then certain roof materials and roof shapes may be more susceptible to wind damage. As one example, a point system may be used to assign point deductions based on weather events and visual detection of specific risk factors. Additionally, points may be deducted for other natural disaster risks, such a wildfire risk. For the case of wildfire risk, risk factors such as potentially flammable fuel being located proximate to a home may be more of a problem in a geographic location having a history of wildfires than in a region rarely having wildfires.

In block 740, a recommended action (or set of actions) is generated. For example, if there is high tree overhang, a recommended action could be to trim overhanging trees.

In one embodiment, the machine learning models used to determine property risk factors are trained based on observational data. In one embodiment, the imagery data is analyzed using tensor flow models. For example, in one embodiment, the machine learning models are trained with labelled data, such as labelled data for roof shape, roof material, the presence or degree of tree overhang, ponding, or rust. More generally, the presence and degree of risk of other property risk factors may be trained using labelled training data, such as the presence of a swimming pool. Other examples include training the machine learning models to detect roof age or roof replacement data, the presence of combustible storage next to building on the property, the count and location of HVAC equipment, ground roughness risk, a vegetation wildfire risk, the presence and degree of previous repairs on the property or the roof, debris on the roof, and yard debris. Other examples include training the machine learning model for the presence of playgrounds, solar panels, neighboring buildings with ballasted roofs.

In one embodiment, a manual quality assurance process is used in combination with machine learning analysis. In one implementation, the machine learning model generates a confidence level factor for each risk factor. The confidence level factor is then used to determine which detections are flagged for manual quality assurance. Providing manual quality assurance is beneficial to address limitations in an initial training data set. However, data from the manual quality assurance may also be used to automatically generate additional training data during the course of use of the machine learning models to improve accuracy. For example, in determining a risk factor for tree overhang, an initial set of training data may be limited in regards to number of different types of trees considered (e.g., pine trees, redwood trees, palm trees, oak trees, elm trees, etc.), different scenarios in which trees overhang a roof composed of different materials, and so on. Some additional manual quality assurance may be desirable if the machine learning model encounters imagery data different enough from previous training data to result in a confidence level below some selected threshold level (e.g., 80%).

The individual property risk factors detected by machine learning models from imagery data may be classified into different tiers (or “buckets”) of risk, such as high, medium and low. This classification is based on visual attributes indicative of a given risk factor. That is, the visual attribute is associated or correlated with a particular risk factor. For example, the numbers of instances or area of a roof covered by overhanging trees may be counted whereas a detection of attributes indicative of particular roof damage or wear & tear may be counted and compared with threshold numbers. A grading model also includes historical weather data or information on historical natural disasters as inputs for a weighted decision matrix. The weighting of a set of detected risk factors is then mapped to a grade for a property, where the grade indicates overall property risk.

For example, in one embodiment, roof shape is classified into several different tiers of risk that determine their scoring for windstorms. Historical weather data on the magnitude and frequency of wind events may then be used in combination with the roof shape (and other roof risk factors) to generate a weighted decision regarding risks from wind. Similarly roof materials may be classified into several different tiers of risk that determine a scoring for hail. In turn, a weighted decision regarding risk from hail may be generated using information on the roof material (and other risk factors associated with the roof) in combination with historical data on the magnitude and frequency of hail events.

In one embodiment, the roof age and a roof replacement date are determined from a machine learning analysis of the imagery data.

In one implementation, the risk factor scores and classification tiers are tuned through multiple simulation to achieve an overall score or grade that is based on a meaningful and accurate representation of risk. In one implementation, insurance claims data is utilized to improve the machine learning scoring algorithm so that the scores are predictive of future claims. For example, the machine learning model may be trained to generate a signal indicative of a loss risk.

In one embodiment, property profiles are triggered based on different criteria. For example, property profiles may be generated on demand; scheduled on a regular basis; triggered by specific events, such as extreme weather events; triggered as follow-on actions to monitor conditions detected in previous profiles; or triggered based on other factors or conditions.

The recommended action for a property may be based on historical information of actions taken for a set of comparable properties having similar risks. For example, historical data on actions recommended by insurers/underwriters may be mined to determine a recommended action.

While a signal indicative of loss risk may be displayed, more generally this is not required. For example, in one implementation a user interface presents recommendations without presenting scoring information or a grade.

FIG. 7B is a flow chart illustrating some examples of customization that can be performed for a particular user in accordance with an embodiment. In one embodiment, in block 745 the risk factor detection and risk tier classification may be customized for an individual user or category of users. In one embodiment, in block 750 users may customize recommended actions for detected risk factors in block 760. In one embodiment, the rule to trigger the running or rerunning of a profile may be customized by a user. In one embodiment, users may customize benchmarks in block 770.

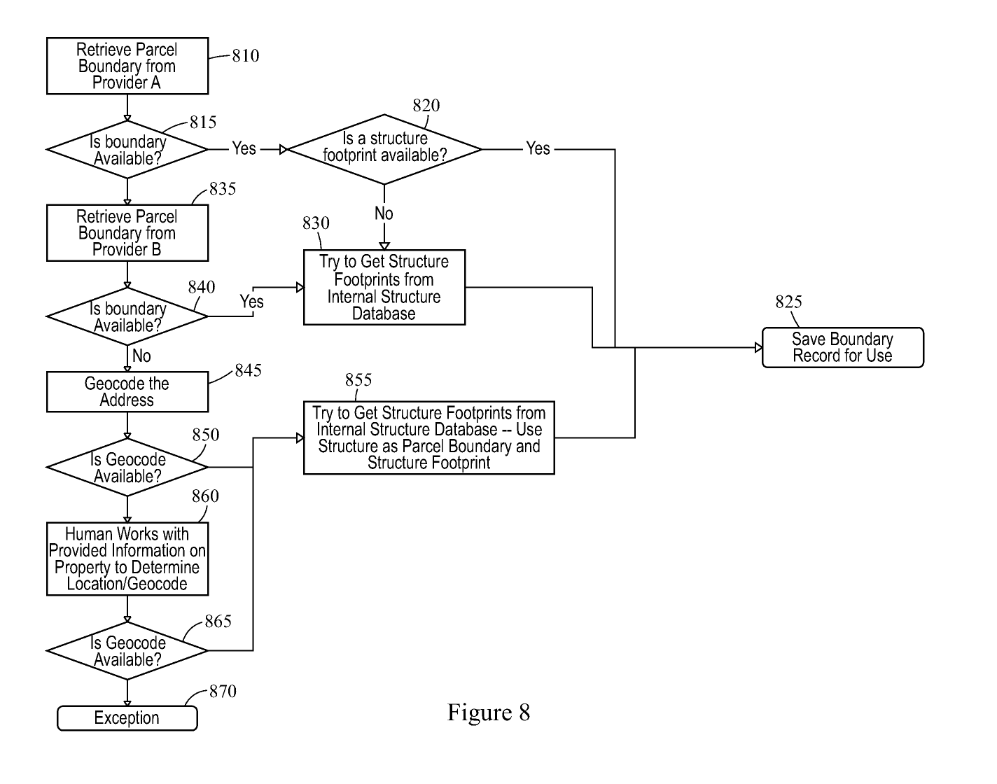

Referring to FIG. 8, in one embodiment the boundaries of a property are determined in a process that takes into account potential limitations of the databases of individual providers of property boundary and footprint information. In one embodiment, the process works in conjunction with a structure shape library that includes structure footprints within a parcel boundary. For example, the structure shape library may aggregate information for assessors' offices and other information. In the example of the flowchart of FIG. 8, a process for determining the boundary of a property attempts to retrieve parcel boundary information from a first provider A in step 810. A decision is made in block 815 whether the boundary information is available from Provider A. If yes, a determination is made in block 820 if a structure footprint is available. If yes, the boundary record is saved for use in block 825. If not, the process attempts to get the structure footprint from an internal structure database in block 830. Returning back to decision block 815, if the boundary information is not available from Provider A, the process optionally moves on other available providers. For example, if there is a Provider B, the process retrieves parcel information from provider B in block 835. A determination is made in block 840 if the boundary information is available from provider B in block 840. If yes, the process moved to block 830. If no, steps are performed to attempt to obtain the boundary information. For example, in block 845, the address is geocoded, using a geocoding service and in block 850 a determination is made if a geocode is available for the address. If yes, then in block 855 the process moved on to get the structure footprint from an internal structure database. If a geocode is not available from the geocoding service, then in block 860 a human being determines the geographical coordinates using the available information, such as by reviewing the property owner name or business name to attempt to identify the property. In block 865 if a geocode is available after human intervention, then the process moves to block 855. If not, an exception is declared in block 870.

The process illustrated in FIG. 8 may be generalized for an arbitrary number of providers. One aspect of the process of FIG. 8 is that it addresses the fact that individual providers, such as mapping services, may have gaps in their databases and/or outdated information. Thus, by seeking information from more than one provider and by providing a manual backup procedure the process provides more complete results.

In some embodiments, a detection of a specific property condition, such as a roof condition, is desired. However, in some situations, various tradeoffs can be made between recency of image data and image quality. That is, the system can select the most relevant source of imagery data based on various factors.

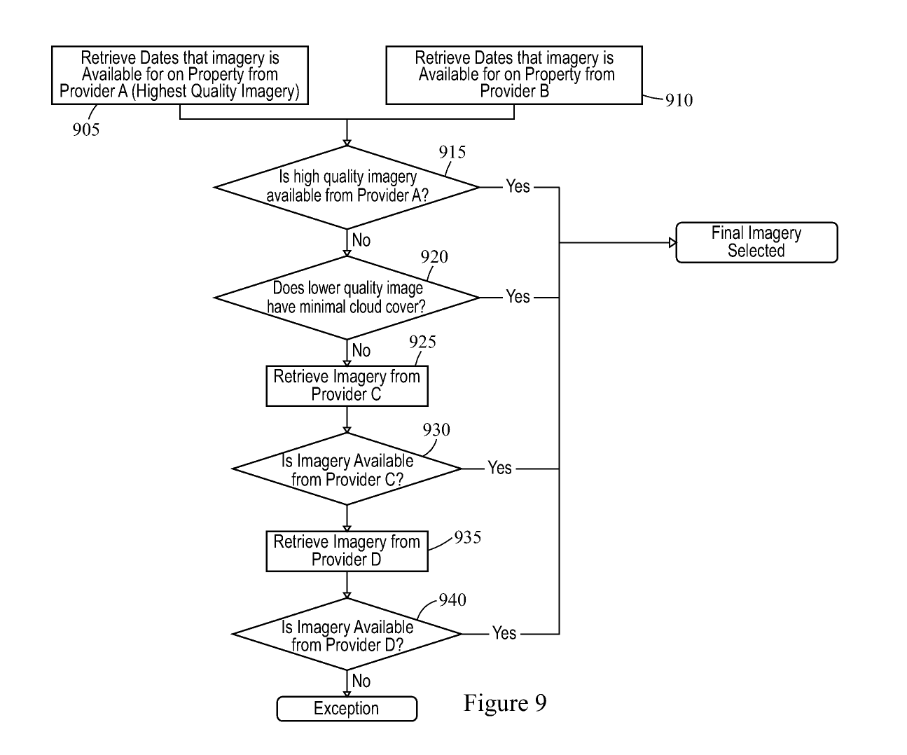

FIG. 9 is a flowchart of a process of selecting imaging data based on image quality and dates information is available. In block 905, dates are retrieved for property imagery data for the property from at least one high quality imagery provider. In block 910, dates are retrieved for property imagery data for the property for at least one lower quality imagery provider. As examples, the high-quality imagery data may be aerial data, and the lower quality imagery data may be satellite data. In block 915, a determination is made if high quality imagery data for the property is available from provider A for a selected data range. If not, the process moves on to consider lower quality data sources for their availability and may also perform additional quality-control checks, such as checking if the image has minimal cloud cover, although more generally a variety of quality-checks may be performed to ensure that the lower quality images exceed a minimal quality required to perform subsequent analysis in later processing steps. Thus, in decision block 920, a determination is made if the lower quality image has an acceptable image quality, such as by confirming that cloud cover in satellite imagery over the property was acceptably minimal. In principal, the process can continue on to other imagery providers in blocks 925, 930, 935, and 940.

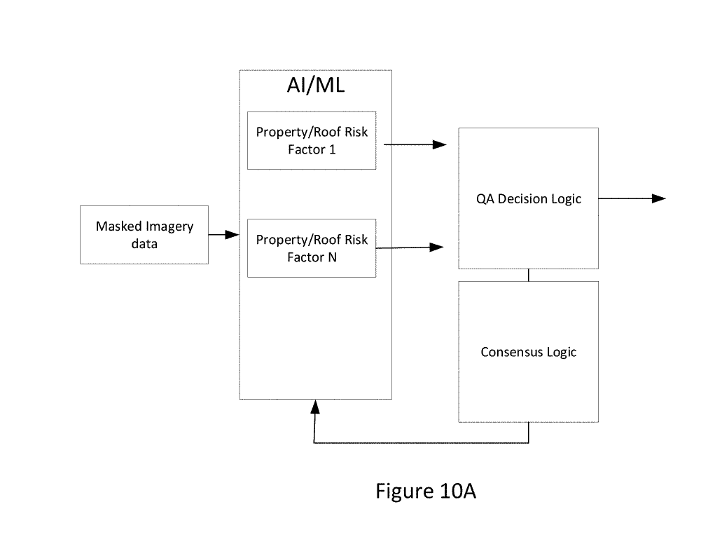

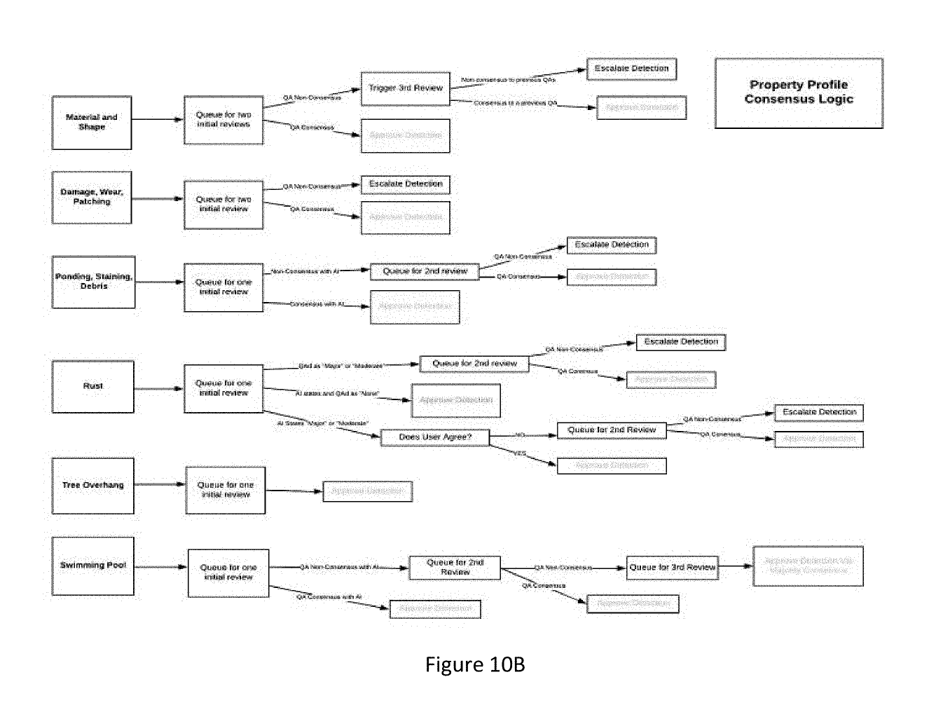

FIG. 10A illustrates a set of AI/Machine learning engine modules trained to detect different roof risk factors and property risk factors from the imagery. In the general case, there may be a set of N different roof factors and property risk factors calculated from the masked imagery data. An additional quality assurance step may be performed. In particular, the AWL modules may output a set of roof risk factors and a confidence level for each risk factor. Based on the confidence level, a decision is then made whether additional quality assurance testing is performed. In one embodiment, if the confidence level for a given roof risk factor is below a threshold level, a consensus approach is used to attempt to reach consensus between the AWL roof risk factor and human observers looking at the masked imagery data. The results from this QA process may also in some embodiments be used to generate additional ongoing data to continually train the AI/ML.

FIG. 10B illustrates an implementation of the embodiment of FIG. 10A in which sets of roof risk factors that are detected from the imagery data includes roof material and shape detection; roof damage detection, wear and patching detection; ponding, staining, and debris detection; rust detection; tree overhang detection; and swimming pool detection. If the confidence level of the AI detection is sufficiently high, then AI detection alone may suffice. However, in one embodiment, human reviewers perform an additional step of quality assurance for each detection that does not exceed a selected confidence level. Property profile consensus logic is provided to approve a detection based on a consensus between the AI results and human reviewers. In one embodiment, the human reviewers perform an mTurk process using Mturk logic to set rules for detection. These consensus results may also be used to generate additional training data to improve the AI detection.

In one embodiment a workflow for performing additional human QA for each detection, that does not exceed a confidence level, in an mTurk workflow process. The number of initial reviews may be chosen as a rule. Specific sequences for triggering subsequent human reviews and/or escalating the detection in a logical sequence. For certain detections, a consensus is required to approve the detection. The full profile of detections is approved after all the individual detections have been approved. A grade may then be determined based on various risk factors and weather factors.

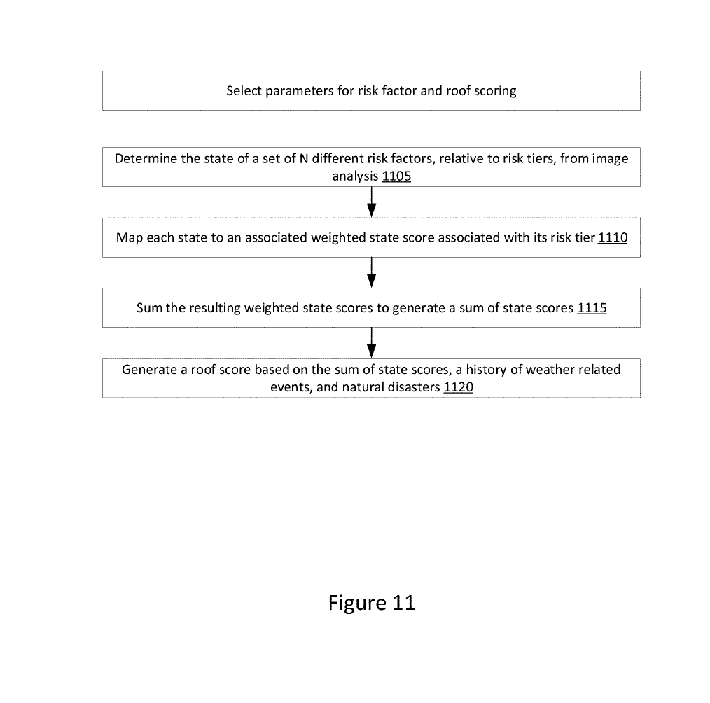

In one embodiment, a roof score is determined based on all of the factors detected from the imagery data. In one implementation, each visual risk factor is converted into a number value. In one embodiment, a sum of the number values for all of the risk factors is used to calculate an overall roof score. FIG. 11 is a high-level diagram of a method of generating a roof score. In step 1105 the state of a set of different roof risk factors is detected from the imagery data through image analysis. In one embodiment, this includes classifying each detected risk factor into a risk tier (e.g. yes/no, high/medium/low, etc.) In step 1110, each state is mapped to an associated state score. In one embodiment, a risk tier for an individual roof risk factor is assigned a score that is weighted to provide a meaningful indicator of risk relative to other roof risk factors. In step 1115, the weighted state scores are summed to produce a sum of state scores.

In step 1120, a roof score is generated based on the sum of state scores. For example, the roof score formula may implement a polynomial or other power-law formula (e.g., linear, binomial, or other higher power equation) with scaling factors and offsets. In this example, the weight factors, offsets, scaling factor and other aspects of the roof score formula may be determined by performing simulation to optimize a fit to real-world claims data or other indicators of real-world roof health or roof risk. That is, the formulas for generating the roof score may be selected to be predictive or indicative of how human evaluators would assess roof health and the need for additional monitoring or repair of the roof.

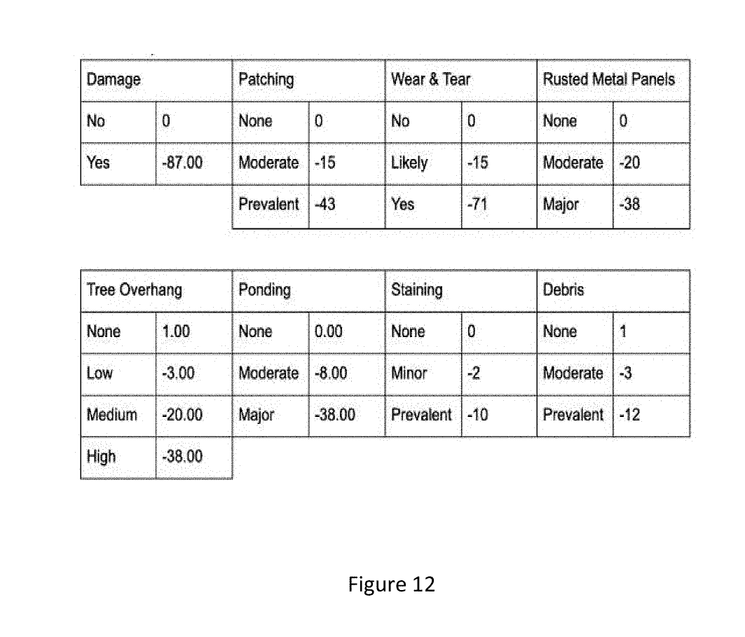

FIG. 12 illustrates an example of how qualitative roof factors are mapped to state scores. For example, a visual detection of roof damage may be assigned a number, such as −87. In this example, each roof factor is classified into a category (e.g., yes/no, low/medium/high, etc.)

In one example, each roof score factor corresponds to a classification into classes such as yes/no or low, medium, and high. Various parameters within imagery data can be assessed and used to map the image into a classification “bucket” for a roof score factor. For example, in one implementation, roof damage is a yes/no classification. In one implementation, the basis for identifying roof damage includes: missing shingles or tiles; broken tiles; tarp(s) on the roof or remnants of tarps on the roof; or a roof membrane ripped off, peeled back, or torn away.

In one embodiment, a patching roof score factor is based on a set of objective and subjective classification rules, such as the number and size of patches. An example classification system is to classify patching into none, moderate, and prevalent/extensive.

In one example, the classification is no patching if there is no visual evidence of patches, mastic, or any previous repairs on the roof(s). Moderate patching is a classification based on a preselected range in the number of detected patches of a selected size. In one embodiment, there is moderate patching if there is evidence of up to 2 previous patches above a minimum size, that are not localized. Alternatively, the classification of moderate patching may apply for a larger number of small patches, such as evidence of up to four patches that are small and widespread.

Classifying patching as moderate based on the number and size of patches reflects some common patching scenarios. For example, suppose some work has been done to make repairs on the roof, but it is not so widespread and abundant so as to indicate that the whole roof is a problem. It is possible that there was an isolated issue that was fixed, or even a large area had issues but was fixed with a large patch.

In one embodiment, extensive (prevalent) patching corresponds to a larger number of patches. For example, five or more patches may correspond to extensive patching, although this number may be adjusted based on the size of the roof. This is because abundant and widespread repairs indicate that the roof is failing throughout.

In one embodiment, a wear and tear roof score factor is based on granule loss. For example, an individual shingle may deteriorate over time through a loss in granules in the shingles. An exemplary classification is no wear and tear, likely wear and tear, and definite wear and tear. In one classification, there is no apparent granule loss if the roof surface appears to be smooth, although various coloration patterns associated with aesthetics of the shingles may be observable. Any patterns in the roof surface are uniform throughout, and do not show the dark anomalies associated with missing granules or raised shingle tabs. That is, there are no anomalies on the roof which would indicate a problem with loss of granules.

In one classification scheme, there is definitive granule loss if there is conclusive evidence of granule loss on the roof and there is enough of it to be certain that it is granule loss (a very small area with the same anomaly may not provide enough signal to be certain). This anomaly shows up as dark stripes, swaths, or patches on the roof. That is, the roof looks old and worn out. It looks like it is at the end of its useful life. Or a manufacturing defect is causing some shingles to deteriorate more quickly than normal, which brings the quality of other shingles into question. In order to be observable from this imagery, the granule loss must be extremely bad to the point that it should be replaced. And even if we only see it on one side of the roof, it is unlikely that the rest of the roof is free of the same problems.

In one classification, possible granule loss corresponds to there being evidence of possible granule loss on the roof, but there is insufficient resolution or size of the anomaly to be certain that it is granule loss. This corresponds to a situation in which there is some question as to the overall quality of the roof, but the available visual evidence is insufficient to confirm what the problem is. The roof may or may not need to be replaced.

In one embodiment, a ponding roof score factor is classified into none, moderate, and major. No ponding corresponds to no clear signs of ponding on the roof. Moderate ponding corresponds to ponding over a range of percentages of a flat roof section. For example, in one implementation, moderate ponding corresponds to areas of ponding that occupy more than 0% but less than 33% of the flat roof section where they are located (exclusive of steep/shingled portion of the roof in this percentage). Moderate ponding on the roof corresponds to ponding substantial enough to warrant maintenance or corrective action. If allowed to persist, it would lead to deterioration of the membrane in several areas or one somewhat sizeable area.

In one classification, major ponding corresponds to a minimum percentage of ponding greater than for moderate ponding. For example, in one implementation, major ponding corresponds to areas of ponding that occupy more than 33% of the flat roof section where they are located (exclusive of the steep/shingle portion of the roof in this percentage). Such extensive ponding represents a substantial risk to the property. It is the defining factor of the roof stemming from a major failure in the drainage design. The ponding on the roof is substantial enough to demand corrective action. If allowed to persist, it would lead to widespread deterioration of the roof or ponds large enough to threaten collapse of the roof.

In one embodiment, a debris roof score factor is classified into no debris, moderate debris, and prevalent debris. No debris corresponds to no apparent debris on the roof. Moderate debris corresponds to isolated areas of debris less than a selected percentage. In one implementation, moderate debris corresponds to isolated areas of debris that cover less than 5% of the roof area are apparent. Very small, possible instances of debris should not be included as part of this tag (a twig, a few random leaves, a small item that isn't quite discernable, etc.). Moderate debris corresponds to a small amount of debris that should be removed but does not appear to pose a risk.

In one embodiment, extensive (prevalent) debris corresponds to a higher percentage of areas covered by debris. In one implementation, extensive debris corresponds to at least approximately 5% of the roof area that is covered by debris. When there is extensive area of a roof covered by debris it corresponds to a substantial quantity of debris on the roof, suggesting that it is a long-term problem that may be deteriorating the roof. It could also indicate poor/lacking maintenance practices.

In one embodiment, a staining roof score factor is classified into none, minor and prevalent. No staining corresponds to the roof surface appearing to be free of staining. No darkened areas are visible (except for shadows, patching, damage, or wear & tear as none of these are considered staining). There is no evidence of staining on the roof. Minor staining corresponds to isolated areas of staining that cover less than a preselected percentage of the roof area. In one implementation, there is minor staining if there are isolated areas of staining that cover less than 20% of the roof area. Other factors may include the staining not being dark or pronounced. That is, the staining is at least either isolated or faint. Prevalent scaling corresponds to dark staining on a selected minimum percentage of the overall roof area. In one embodiment, staining is prevalent if there is dark staining on at least 20% of the overall roof area. As an example, staining may form from deposits around exhaust vents.

In one embodiment, a rust roof score factor is classified into none, moderate, or major on the metal panels of a roof. No rust corresponds to no visual evidence of rusted metal roof panels in the picture. If there are no metal roof panels in the photo, then there can be no detection of rust. Moderate rust corresponds to there being some localized rust on a roof taking up less than 20% of the roof area. In one implementation, moderate rust corresponds to widely dispersed rust on a roof, but it is very slight in each instance that it appears (covers less than about 20% of the overall roof area).

A property with multiple buildings includes one relatively small metal panel roof that has any amount of rust. In one embodiment, major rust corresponds to rust being widely dispersed on a roof, such that it covers a large selected percentage of the overall roof area (e.g., more than about 20% of the overall roof area).

In one embodiment a tree overhang roof score factor is classified into none, low, medium, and high. No tree overhang corresponds to no trees overhanging the roof. Low tree overhang corresponds to trees overhanging the roof but within some minimal threshold percentage of overall roof area. For example, in one implementation, low tree overhang corresponds to a range of overhang in which up to 5% of total roof area is covered by overhanging trees. The threshold percentage may be adjusted based on different factors. For example, for a large property, the percentage may be adjusted to account for changing ratio of perimeter-to-surface area. For example, for a large property, the threshold percentage could be adjusted to be 1% to 5% of the roof being covered by overhanging trees. Alternatively, for a large property, low tree overhang could be defined by the number of instances of tree overhang. For example, in one implementation, corresponds to 3 to 6 instances of even minor tree overhang.

In one embodiment medium tree overhang corresponds to a somewhat larger percentage range of total roof coverage. For example, for a small property, medium tree overhang may correspond to 5% to 25% of the roof being covered by vegetation. For a larger property, a different range may be used, such as 5% to 10% of the roof of a larger property being covered by overhanging vegetation. Alternatively, for a larger property, medium tree overhang may be defined by a range in the number of instances of minor tree overhang, such as 6 to 12 instances of even minor tree overhang.

In one embodiment, high tree overhang corresponds to a high percentage of roof area covered by overhanging trees. For example, in one embodiment, high tree overhang corresponds to more than about 25% of roof area being covered by overhanging trees. For a large property, a different percentage may be used, such as more than 10% of the roof being covered by overhanging vegetation. Alternatively, for a large property, a high tree overhang corresponds to a selected minimal number of instances of tree overhang. In one example, high tree overhang corresponds to more than 12 instances of tree overhang.

It should be noted that many of these roof score factor classifications have factors that can be adjusted based on empirical factors. For example, tree overhang creates the risk of tree limbs falling onto a roof in inclement weather, such as during a windstorm or a heavy snow. The percentage of the roof underneath tree limbs gives some indication of potential risk. The number of instances in which tree limbs overhang the roof gives another indication of potential risk. The percentage of roof coverage or the number of instances of overhang can be weighted to form classifications that are relevant to understanding risk for a property of a given size.

Similarly, for the most general case, a risk factor detection can be classified into two or more “buckets” and weighting factors adjusted to give useful classification into categories such as none, low, moderate, or high. In a real-world application, the formulas for the roof score factors would have adjustable parameters tweaked so that the final roof score produces a relevant score with respect to indicators of real-world roof risk, such as from insurance claims data.

Some other risk score factor detections and classifications include detecting and classifying a worn coating, a ballast displacement, a presence of a tarp, a faded EPDM (roof membrane), a presence of a parapet, parapet height, building or roof under construction, yard debris, propane tanks, HVAC units, exhaust deposits on a roof, ridging shingles, raised shingle tabs, solar panels, trampolines, playgrounds, or a deck.

In one embodiment, the scoring thresholds are optimized based on insurance claims data. For example, in one embodiment, an insurer provides a list of properties and relevant claims experience for those properties and any comparable properties. The thresholds in the roof score factors and the roof score are then adjusted to create an optimized scoring algorithm for the insurer's book of business. Additionally, key score thresholds may be identified that warrant further scrutiny by the insurer. As an illustrative example, in one implementation, an insurer provides a list of properties and their associated claims experience, including properties with and without claims. The system is then used to conduct a Property Profile inspection as of the binding date of the policy for each location. Key predictors of losses are identified along with an optimized scoring algorithm for that insurer's book of business, which may include specifying the key score thresholds which warrant further scrutiny.

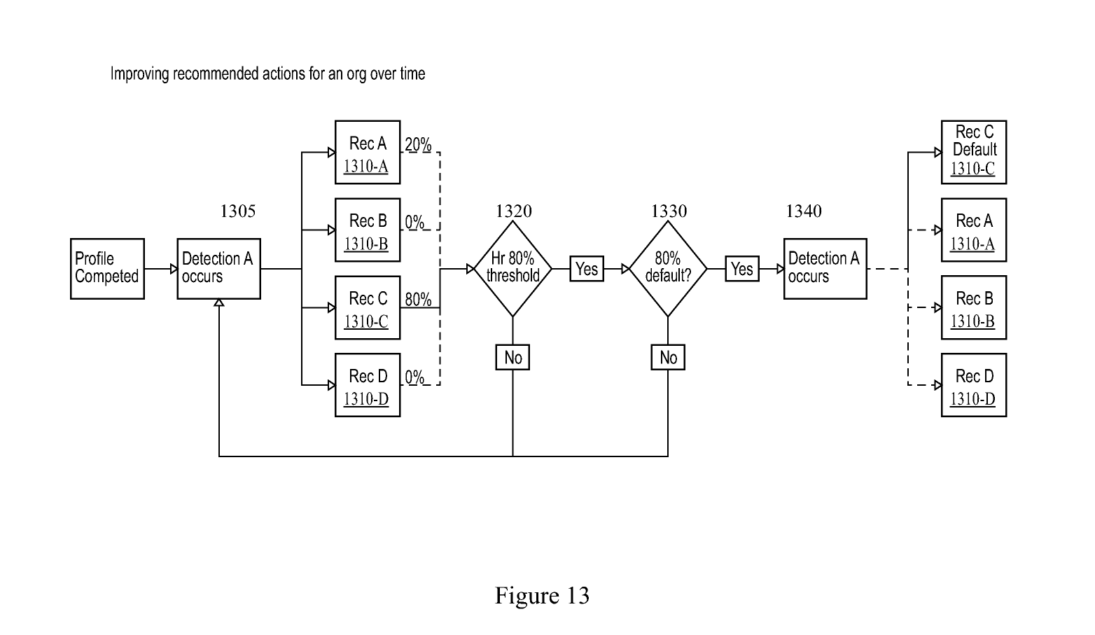

Referring to FIG. 13, in one embodiment, the system implements a process of providing and improving recommendations, which may be to an entity such as an insurer or underwriter. An individual detection (e.g., roof damage or tree overhang) may be classified into at least two priority buckets, such as low, medium and high. Thus, in the example of FIG. 13, detection A 1305 could be any detection made from the imagery data, which is classified into two or more classes, such as low, medium, and high. In this example, each detection has a preset list of recommended actions to prescribe to the situation. As examples, some common recommendations may include making repairs/replacements, further inspection, monitoring the situation, taking no action, or logging a change to a policy. For example, for high tree overhang, a first recommendation A may be to order tree trimming, a second recommendation may be ordering an inspection, a third recommendation would be to monitor the tree overhang, a fourth recommendation would be to take no action, and a fifth recommendation would be to log a change to the insurance policy (e.g., to not continue a particular form of insurance, enact a higher deductible in the future, etc.)

More generally, recommendations could be customized for a given detection. In one embodiment, a recommendation has an associated action and an optional target compliance date.

One aspect of the process illustrated in FIG. 13, is that it permits the recommendations to be optimized for individual insurers/underwriters. In particular, if an entity has a large enough sample size of decisions made for a given detection, the system can monitor if any of the recommended actions hit a preselected threshold, such as 80%. For example, if the detection is roof damage and more than 80% of the time the recommended action of the entity is to immediately repair/replace the roof, then a decision can be made whether this recommendation should be automatically generated by the system as a default.

Over time the process looks for and measures convergence in thought along with an entity selecting recommendations (e.g., an underwriter by determining how often a specific action is chosen for a given detection.

Once a customer has a large enough sample size of decisions made for a given detection, the process can start to monitor if any of the recommended actions hit the selected threshold (e.g., an 80% threshold).

For example, when Detection A 1305 occurs, an entity (e.g., an insurer or underwriter) may choose recommendation 1310-C 80% of the time, Recommendation 1310-A 20% of the time, and other recommendations, such as Rec 1310-B or 1310-D 0%. Those are just illustrative examples. In decision block 1320, a decision is made regarding which recommendation hitting a preselected threshold (which in this example is 80%). A decision is then made in block 1330 whether this should be used as a default recommendation when the detection occurs. For example, suppose that in response to detecting high tree overhang that 80% of the time an underwriter recommends immediate tree trimming. After a meaningful sample size of results are obtained, a recommendation may be provided to the underwriter to have the system generate that as a default recommendation. If the underwriter accepts the default setting, then in a subsequent detection A 1340, Rec C (1310-C) is provided as a default recommendation.

The process of FIG. 13 may be generalized further to use sample data for how an organization, such as insurer/underwriter, uses a detection of a risk factor in making recommendations, identifying consistent patterns in the recommendations, and suggesting a default rule based on the pattern. This improves consistency across an organization. For example, the sample data may be collected for experienced agents of the insurer/underwriter to identify patterns in their recommendations and the recommended default recommendation would spread consistency of this pattern to more junior agents.

The number of responses required to generate default recommendations may be determined based on a threshold statistical confidence level, which in turn implies a minimum sample size. Alternatively, information on selection rations and percentage could be displayed next to recommendations for a detection. As example, for a detection of moderate ponding, each recommendation could be displayed with the associated ratios or percentages with which it was previously selected for moderate ponding. For example, moderate ponding, Rec A could be displayed with indicator that in the previous 500 detections of moderate ponding, it was chosen 100/500 times, or 20%).

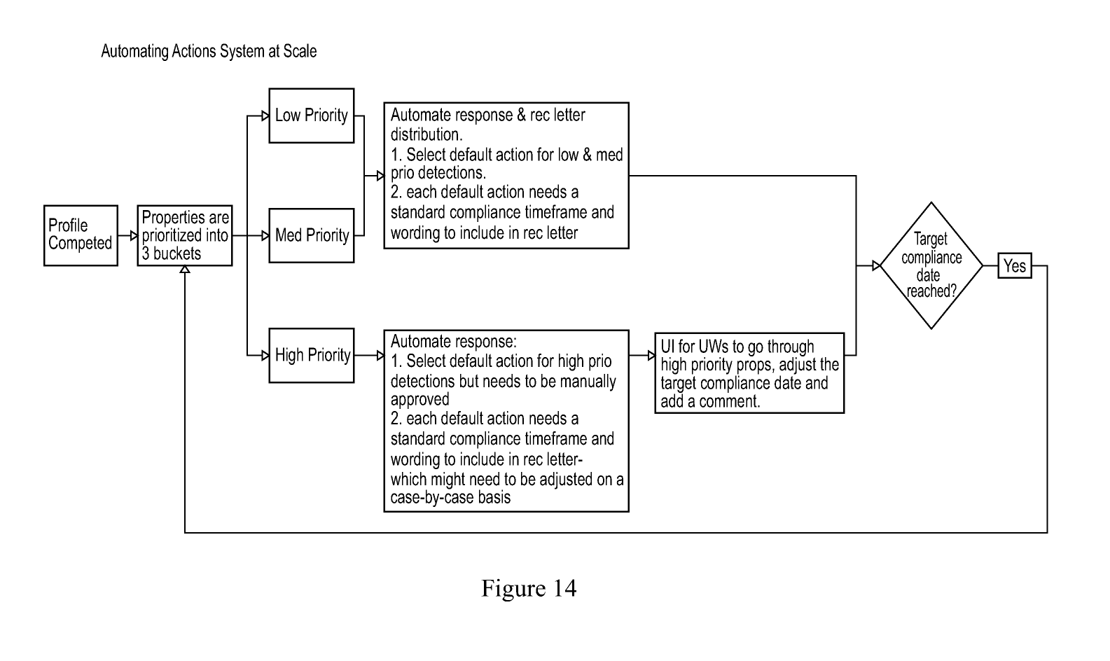

FIG. 14 illustrates a process for automating recommendation process over the portfolios of numerous properties. In this example, default actions are selected based on a prioritization associated with one or more detection. In theory, there could be automation of all letters. However, in one implementation, at least high priority default actions are subject to an additional optional manual review. This allows customization of wording or other aspects of the recommendation on a case-by-case. In effect, the system is generating a draft recommendation letter, which may further be manually revised or customized. In one implementation, for low and medium priority detections, the system auto selects and approves recommendations. For high priority detection, the system auto selects recommendations, but the recommendations require final approval by the insurer/underwriter.

In some embodiments, queues are provided to quickly review recommendations and approve or revise them. In some embodiments, a set of standard compliance timeframes are included for each action in each recommendation letter. In one embodiment, the system also monitors the target compliance date and takes it into account when a profile is run. For example, suppose that an initial detection is performed in January. A recommendation is generated, such as to trim overhanging trees within four months (before the next hurricane season). When the next profile is run, in June, validation may be performed that the actions outlined in the recommendation letter were remedied. For example, the recommendation letter will automatically adjust if the actions have been remedied. However, if it hasn't been remedied, the recommendation letter may be customized for that.

In one embodiment, benchmarks are provided for users. In one embodiment, the benchmarks are benchmarks in a geographic area (e.g., state-wide benchmark), a climate/weather zone (e.g., regional hurricane-zone tornado zone etc.), a combined geographic/climate/weather zone geographic/climate zone (e.g., Rocky Mountains alpine zone), or other geographic risk zone (e.g., wildfire risk zone). Another example of a benchmark is a benchmark with respect to other properties in a selected set of properties. For example, the properties may be other commercial or residential properties insured by an insurer/underwriter, other commercial or residential properties owned by the owner of a particular property, or a selected group of properties profiled by the system (e.g., a set of comparable properties based on some set of metrics such as size of business or an insured amount). For a benchmark set of properties, averages may be calculated and tracked over time.

In one embodiment, a user interface is provided for a user to customize features. Examples of customization include setting a risk tolerance for a portfolio, such as customization of detection and their priority (e.g., high, medium, low), customization of action to recommend for particular issues. Another example of customization include establishing rules to trigger a re-run of a profile. For example, a rule could be customization to trigger a re-run of a profile to detect a change in a roof profile or to perform certain detections according to a pre-selected schedule (e.g. once every six months during the term of an insurance policy or after an insurance claim as a “checkup”). Another example of a rule to trigger a re-run of a profile is to automatically re-run a profile for all properties in an area affected by a catastrophe, such as a hurricane or earthquake.

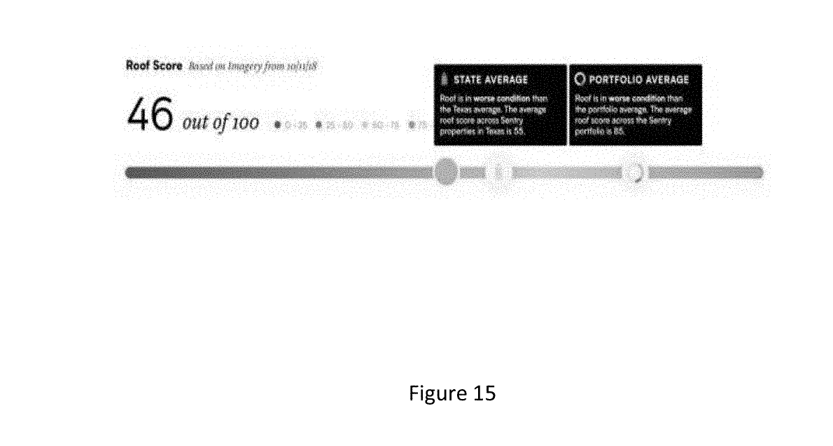

FIG. 15 illustrates an example of a roof score compared with benchmark state averages and portfolio averages. In this example, the roof score is presented with an ability to access other benchmark data, such as a state average of roof scores for comparable properties, such as properties insured by the same underwriter. In one embodiment, access is provided to other benchmarks, such as a national portfolio of properties.

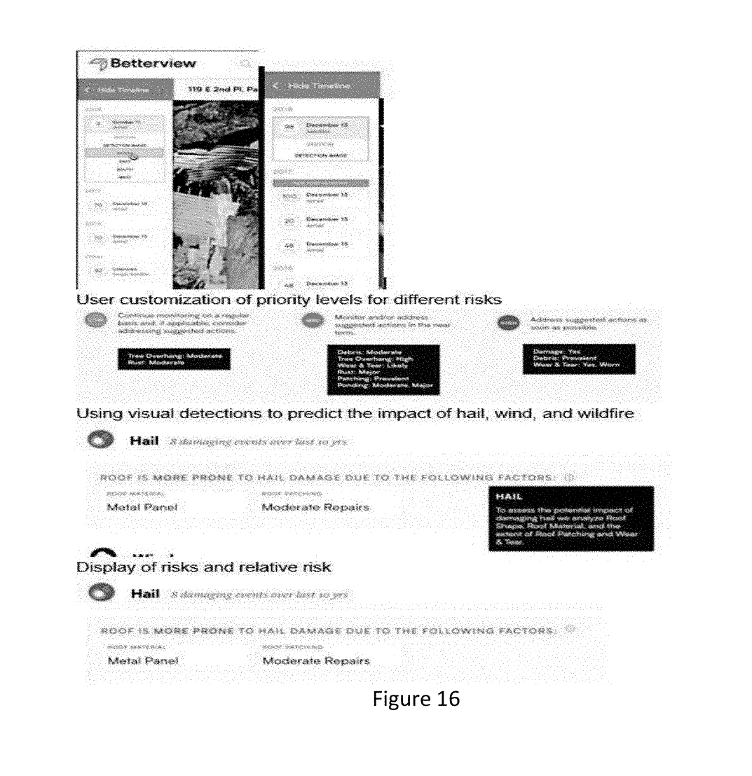

FIG. 16 illustrates an example of user customization of priority levels for different risk and associated actions. In this example, the user is provide with a notification of the priority level (e.g., low, medium or high) for one or more risk factors. Additionally, the recommended action may also be displayed (e.g., continue monitoring for low risk, address suggested action in the near term for low risk, and address suggested actions as soon as possible for high risk.

In one embodiment, the potential impact of risk factors is displayed. For example, a profile based on the imagery data may display a list of risks and relative risk, such as an enhanced risk of hail damage due to the roofing materials and previous patching of a roof.

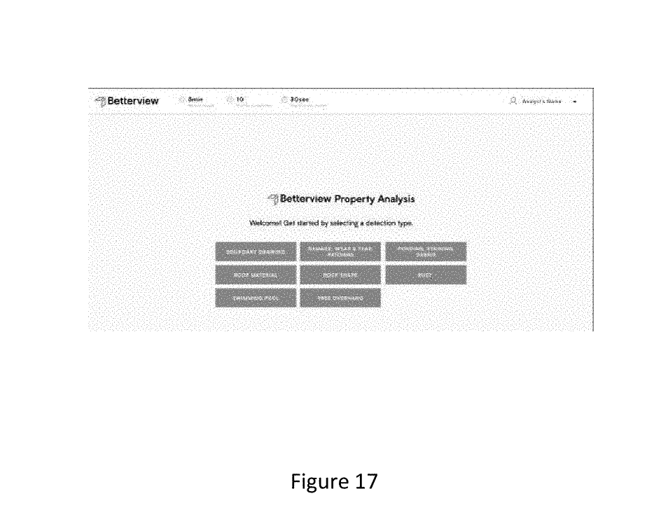

FIG. 17 illustrates a user interface in which a user can select a detection type, such as boundary drawings, roof material, swimming pool, damage, wear & tear, patching, roof shape, tree overhang, ponding, staining, debris, and rust.

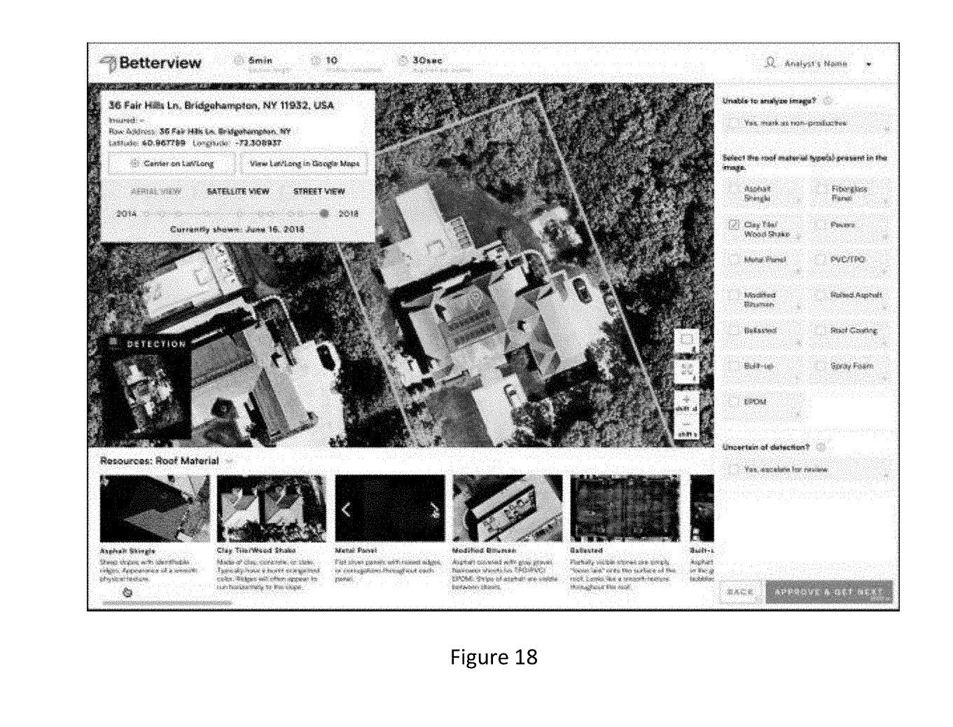

FIG. 18 illustrates an example of a user interface to label attributes of an image. In this example, the user interface permits a selection of the type of roof material. The labelling of attributes may occur, for example, to generate training data during a quality assurance step. While roof material is one example, more generally the user interface may provide options for labelling attributes of other risk factors.

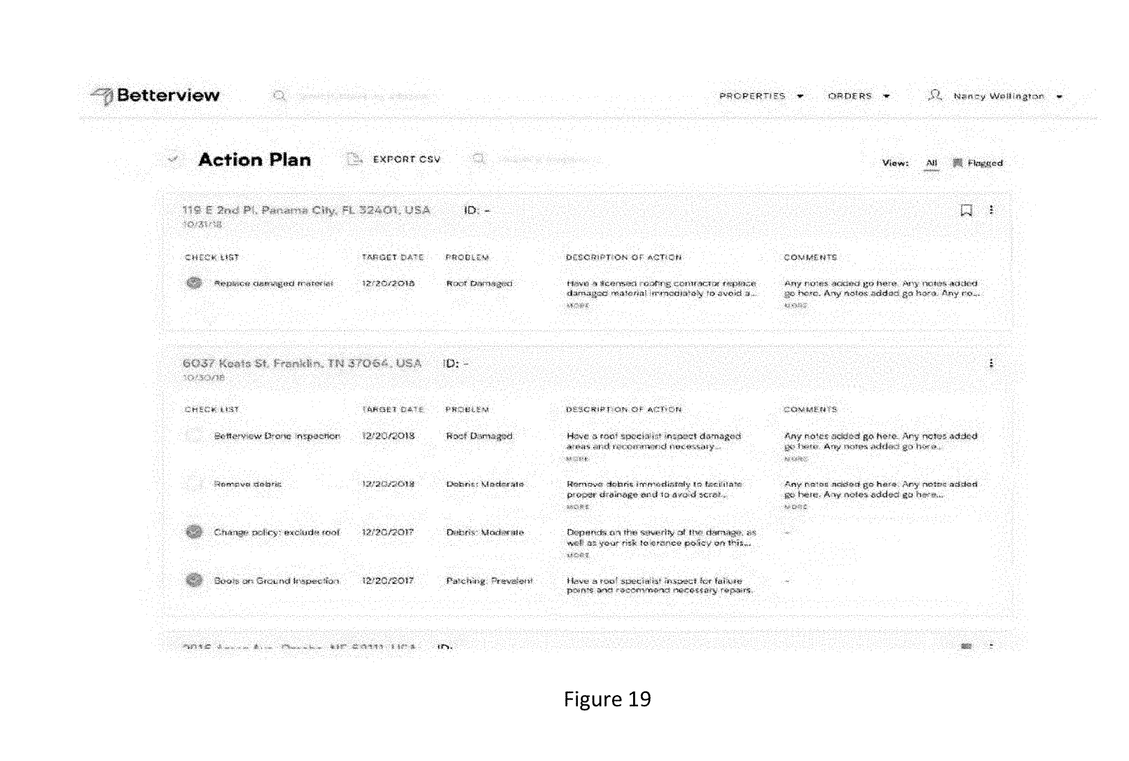

FIG. 19 illustrates an example of a user interface showing an action plan. The action plan includes a description of actions and any associated user comments that have been entered. In this example, the check list includes remediation (repair) of damaged material removing debris, changing the insurance policy, and inspections. Each action has an associated target data, a description of the problem, and a description of the action.

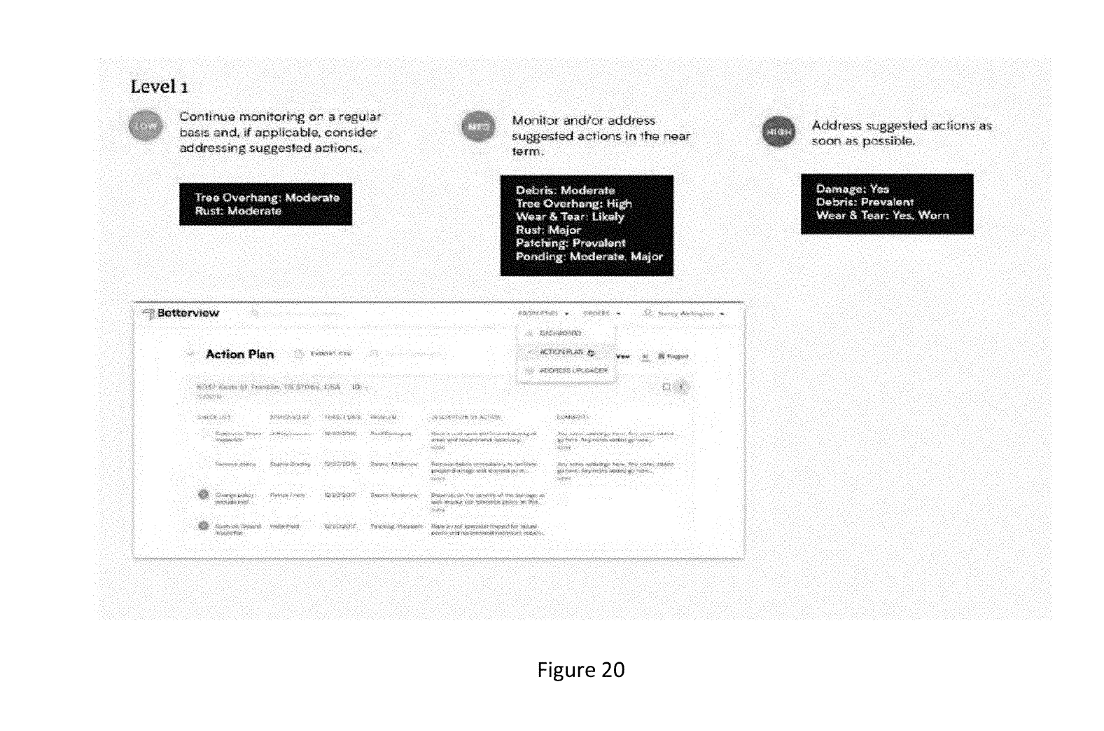

FIG. 20 illustrates displaying risk factors and suggested actions by priority. In this example, drilling into the action plan permits the action plan to be displayed with items listed at different levels of priority for taking action, such as low, medium and high.

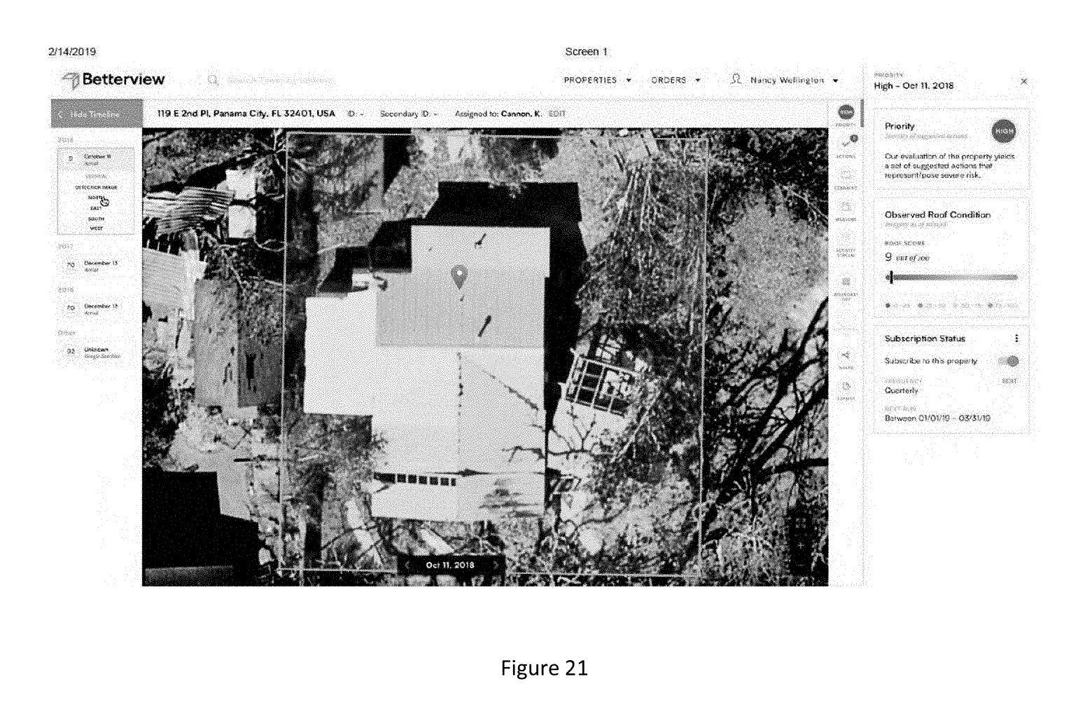

FIG. 21 illustrates an example of a user interface displaying an image of a property showing roof damage, a roof score, and subscription plan to monitor the property according to a schedule. In this example, the profile is automatically triggered to rerun.

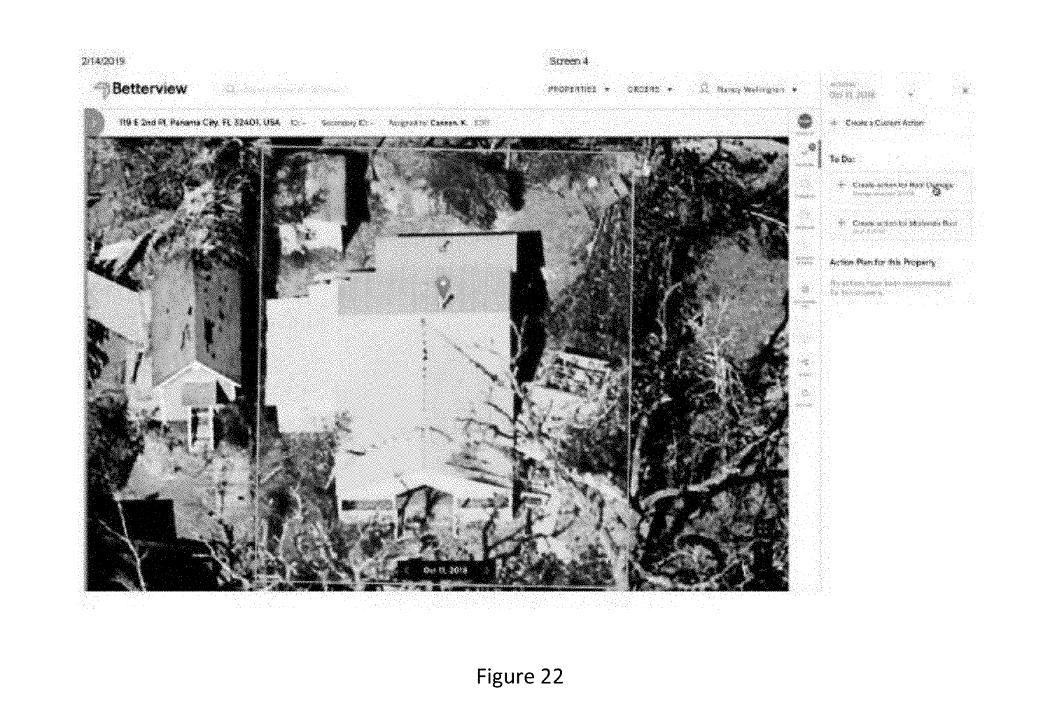

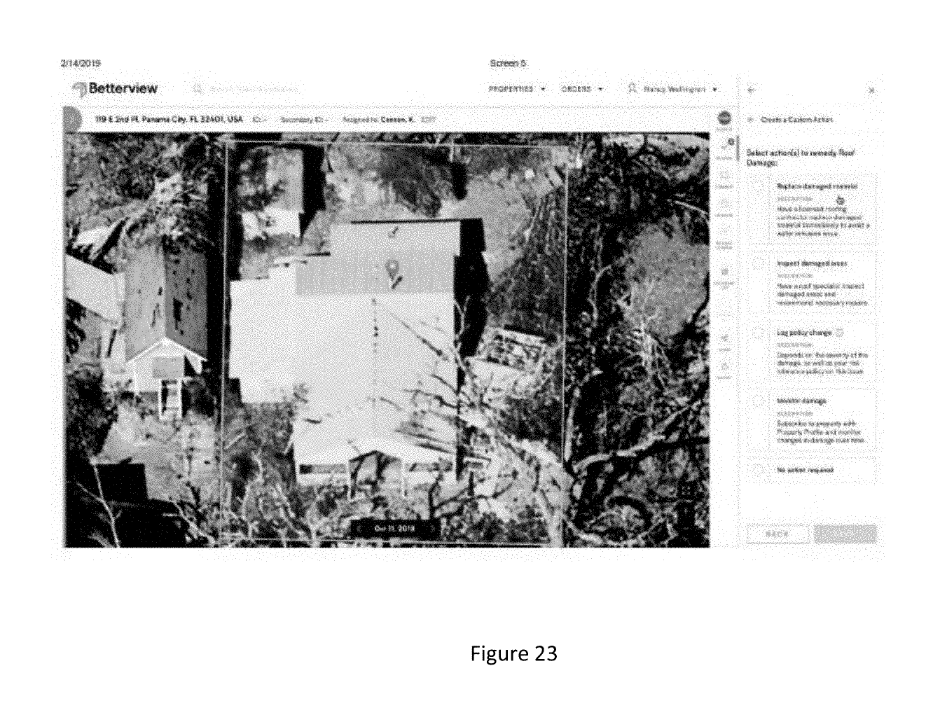

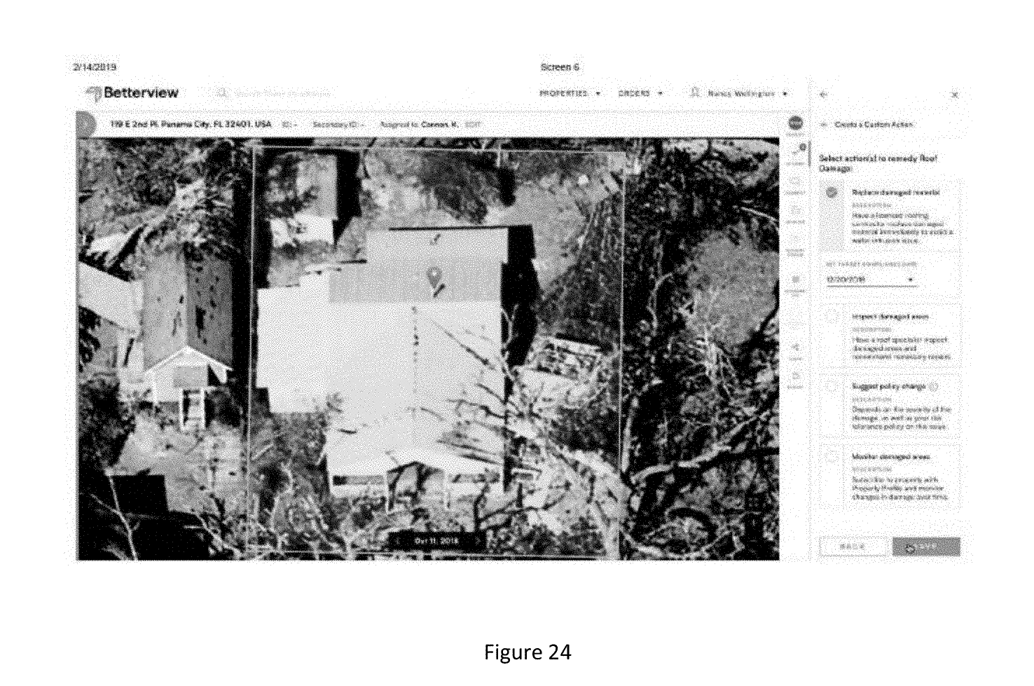

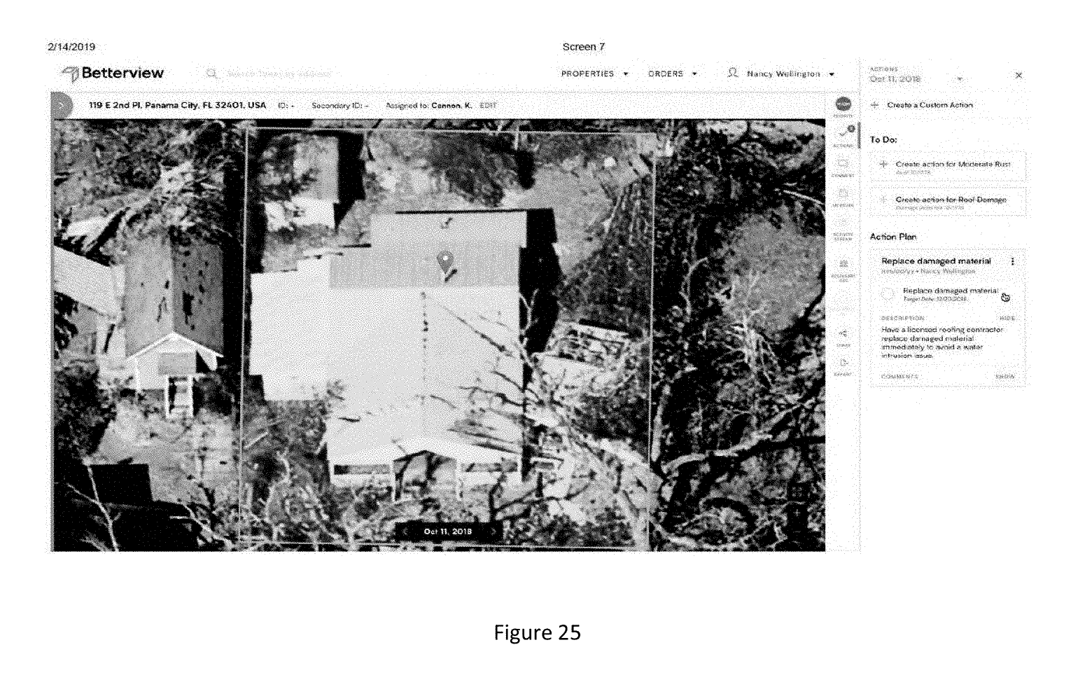

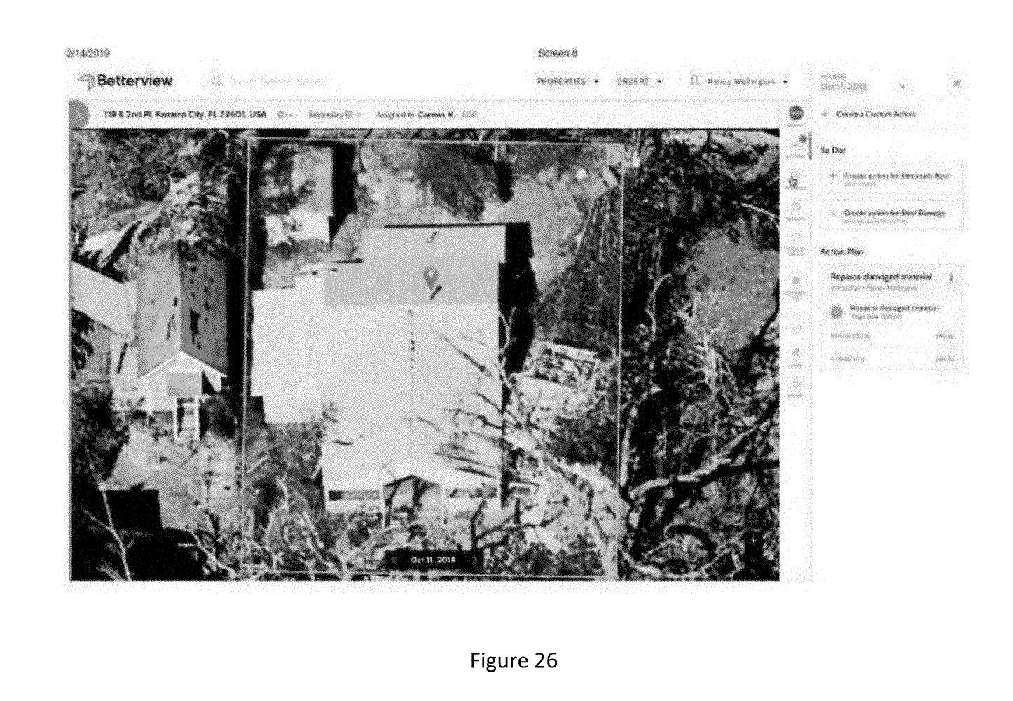

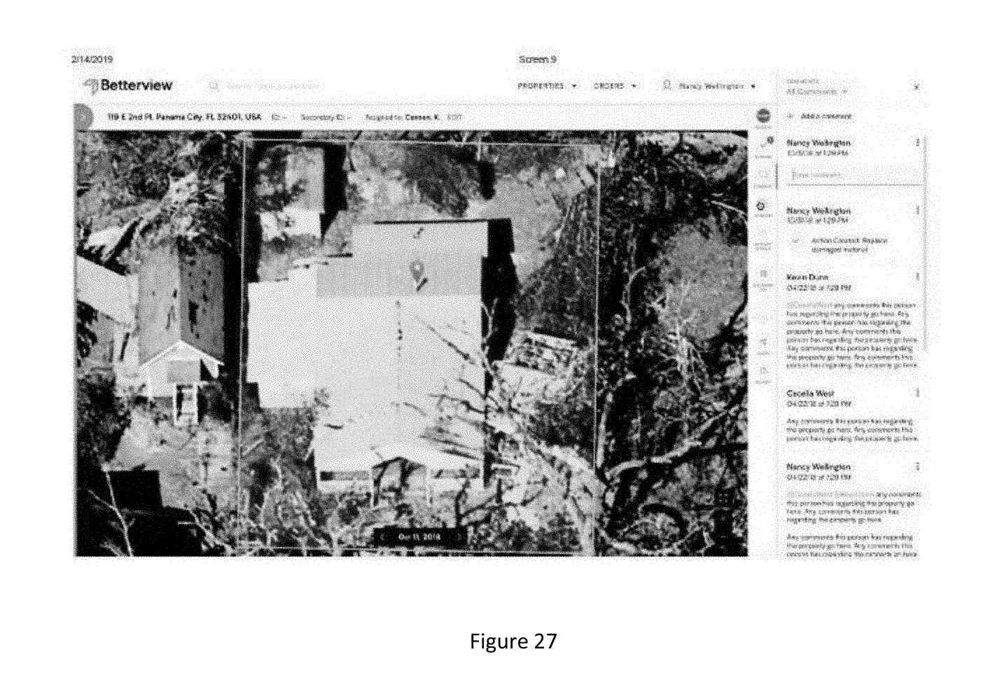

FIG. 22 illustrates an example in which the user interface permits a user to enter custom actions for the property. Additionally, a user may create an action for the property, such as creating an action for roof damage and rust. FIG. 23 illustrates the user interface providing a set of default actions to remedy the roof damage, such as a replacement of damaged material, inspection of damaged areas, logging a policy change (e.g., to change the insurance policy when it comes up for renewal), monitoring damage, or taking no action. FIG. 24 illustrates a user selecting the option to replace damaged materials. FIGS. 25 and 26 illustrate other examples of user interfaces in which a default action plan (“Replace damaged material”) is suggested, subject to user verification. FIG. 27 illustrates an example of the user interface recording user comments or notes.

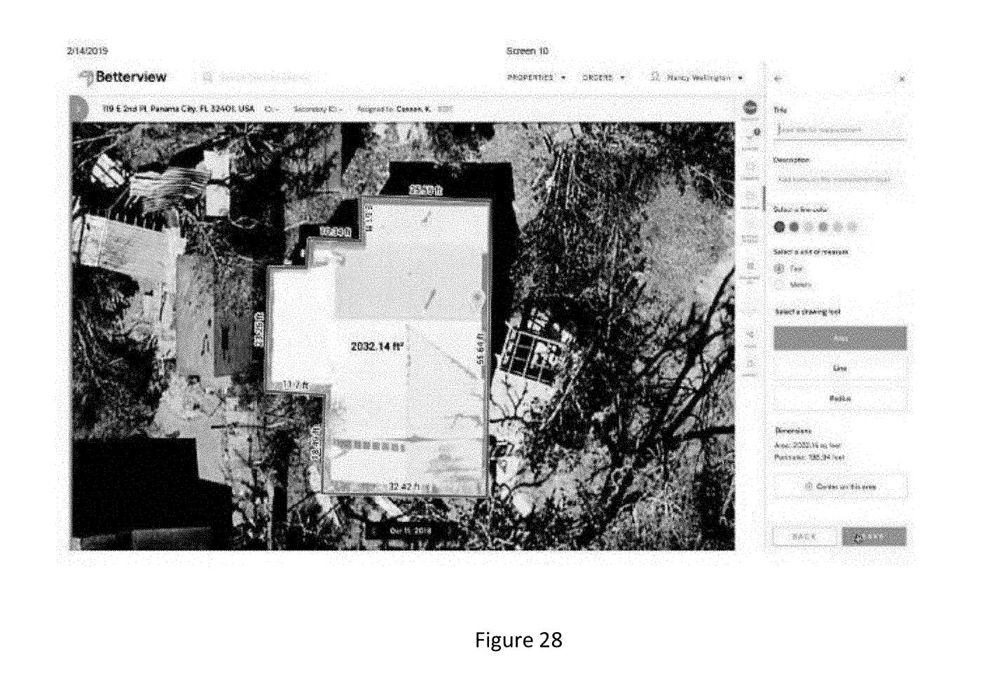

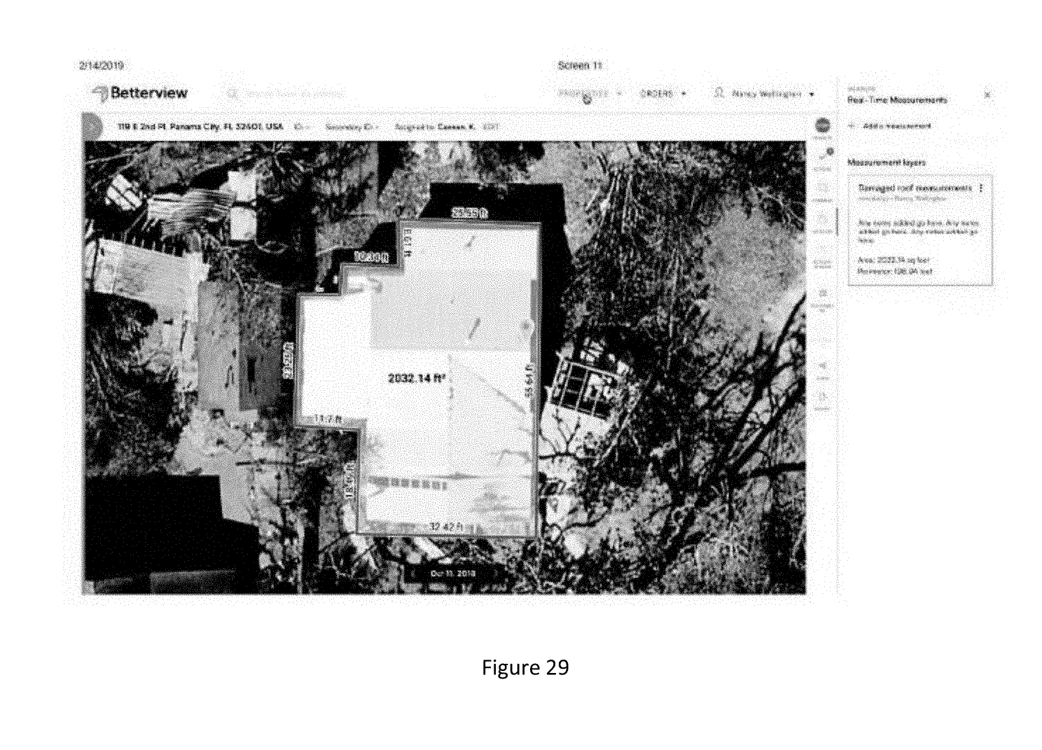

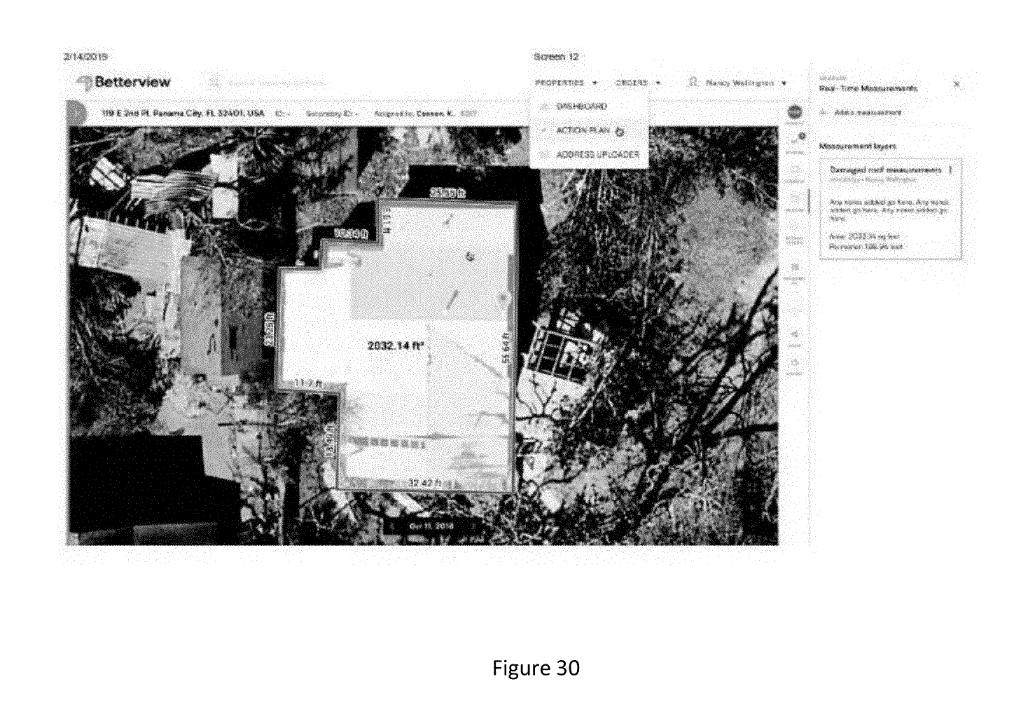

FIG. 28 illustrates an example of a user interface that displays damaged roof dimensions. FIG. 29 illustrates the user interface saving the damaged roof measurements and FIG. 30 illustrates the user interface returning to an action plan view.

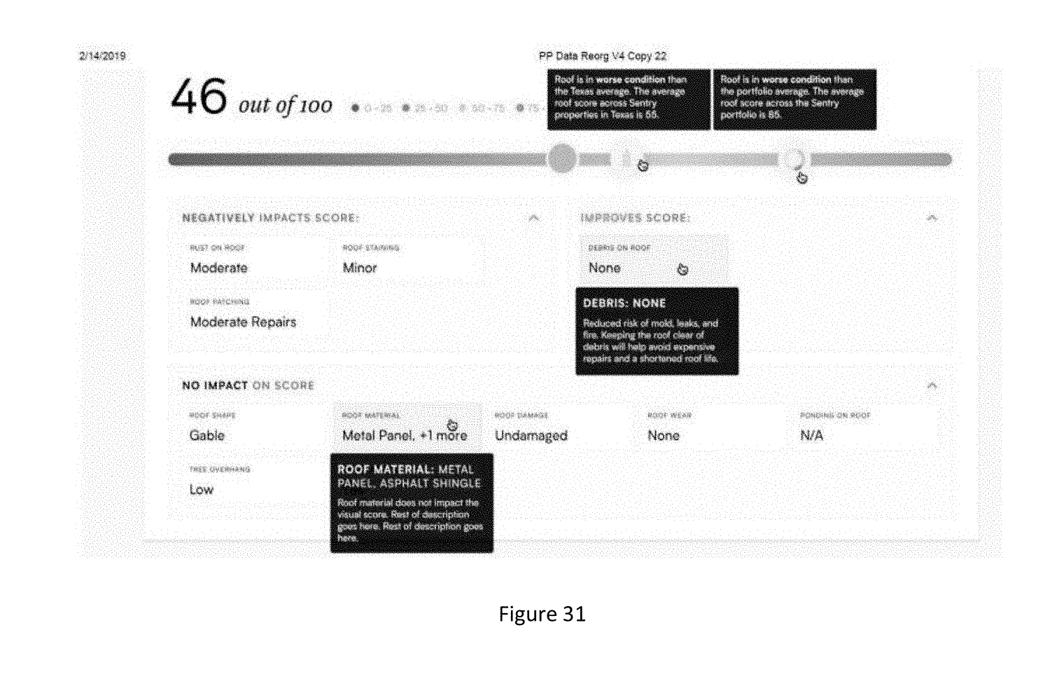

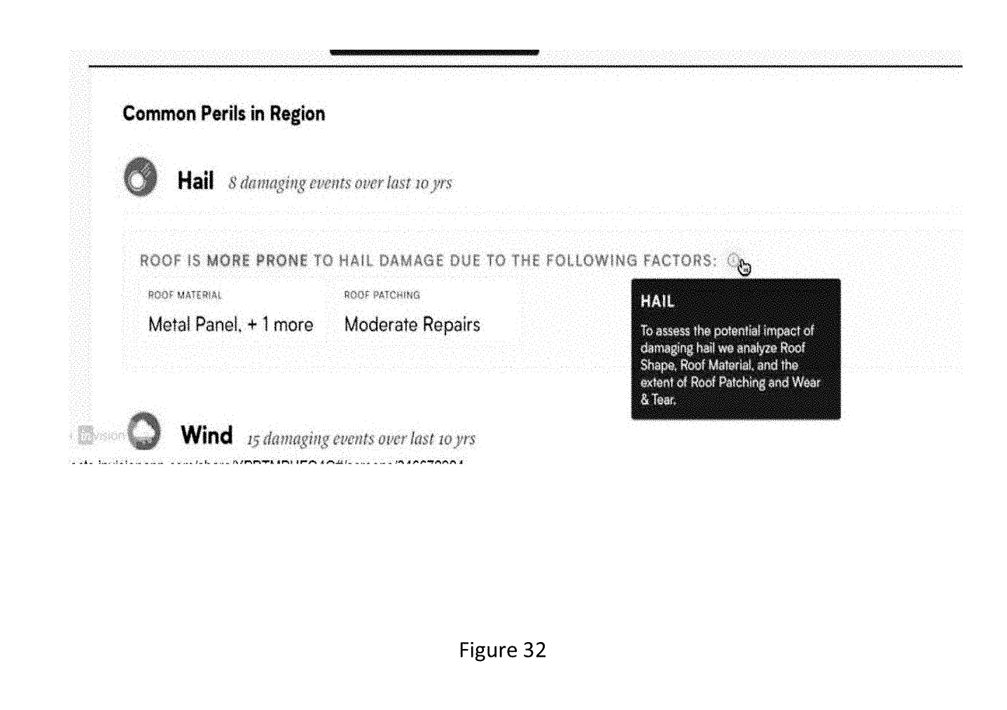

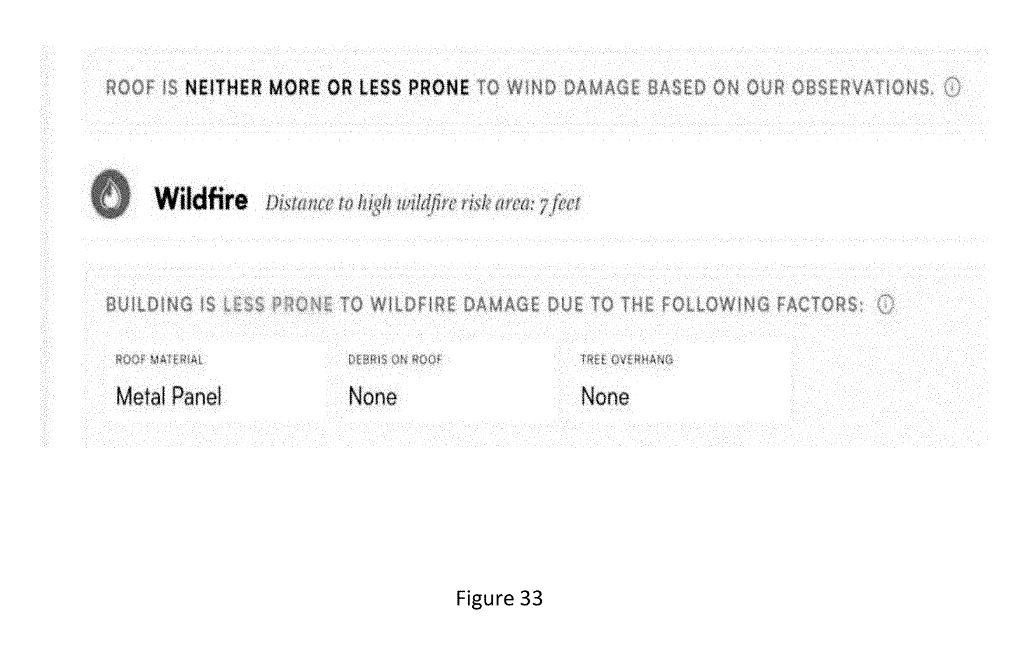

FIG. 31 illustrates an example of a user interface displaying benchmarks and factors impacting scores of individual risk factors. For example, pop-up windows may display what factors negatively impacted the score, what factors could be used to improve the score, and what factors do not impact the score. In this example, the user interface provided feedback for a user to better understand the condition of the roof, tradeoffs, and action items. FIG. 32 illustrates common perils in a region and roof factors making the roof more at risk from the peril. For example, for hail damage, the user interface may display that the roof materials, and roof shape make the roof more susceptible to hail damage. FIG. 33 illustrates another example of a peril in the form of a wildfire, shown factors related to the susceptibility of the building to fire.

### OTHER ILLUSTRATIVE EXAMPLES

Many different combinations and permutations of the previously described features are contemplated.

In one embodiment, at least one image of a structure on the property is obtained. The image is analyzed to identify specific attributes predictive of a loss risk. For example, a set of annotation, such as a set of fields, may be filled out for a set of specific attributes indicative of a loss risk. For example, the set of specific attributes predictive of loss risk may include two or more attributes related to a loss risk for a roof or other feature of structure on a property. The set of specific attributes is aggregated to form a signal indicative of loss risk. For example, a set of specific attributes predictive of a loss risk for a roof may be aggregated to form a signal indicative of a loss risk for the roof.

A set of additional non-limiting examples is provided below.

### Example Set I

### Example 1

A computer implemented property investigation method comprising:

determining property boundary information for a property;

selecting image data available for the property satisfying a set of conditions including the property boundary information, a minimum image quality for imagery data, and a recency range for imagery data;

masking the imagery data using the boundary information to generate masked imagery data;

performing an image analysis of the masked imagery data via a machine learning model trained to detect attributes of a set of property risk factors from the masked imagery data; and

generating an overall property score based on the detected set of property risk factors.

### Example 2

The method of Example 1, wherein generating the overall property score further comprises accounting for at least one of historical weather events and historical natural disasters such that the overall property score is indicative of a risk for the property to face future weather events or future natural disasters.

### Example 3

The method of Example 1, wherein generating the overall property score further comprises accounting for historical weather events and natural disasters with the overall property score being assigned a grade indicative of a condition of the property to face future weather events or natural disasters.

### Example 4

The method of Example 1, wherein the machine learning system is further trained based on an initial set of training instances of labelled images.

### Example 5

The method of Example 1 wherein the overall property score is a roof score of a building structure on the property and the property risk factors that are detected include a set of roof risk factors comprising at least one of: roof damage, roof patching, roof wear & tear, roof rust, roof tree overhang, roof ponding, roof staining, and roof debris.

### Example 6

The method of Example 5, further comprising: classifying each roof risk factor into a tier of risk based on one or more detected attributes of the risk factor.

### Example 7

The method of Example 6, further comprising: assigning a state score for each roof risk factor based on its tier of risk, summing the state scores to produce a sum of state scores, and using the sum of state scores to determine a roof score.

### Example 8

The method of Example 1, further comprising: determining a confidence level, for an accuracy of machine learning detection, for each detected property risk factor; and for each detected property risk factor having a confidence level below a pre-selected threshold, performing a secondary manual detection.

### Example 9

A computer implemented property investigation method comprising:

determining property boundary information for a property;

selecting historical weather data and natural disaster data for a geographic location associated with the property;

selecting imagery data available for the property satisfying a set of conditions including the property boundary information, a minimum image quality for imagery data, and a recency range for imagery data;

masking the imagery data using the boundary information to generate masked imagery data;

performing an image analysis of the masked imagery data, via a machine learning model trained to detect attributes of a set of roof risk factors of building structures of the property from the masked imagery data, the detection including detecting a presence or a degree of each roof risk factor of the set of roof risk factors from the image analysis;

assigning a score to each detected risk factor based on its presence or degree; and

generating an overall roof score based on the historical weather data, the historical natural disaster data, and a weighted distribution of the scores assigned to each roof risk factor from the set of roof risk factors.

### Example 10

The method of Example 9, wherein generating the overall roof score is indicative of a risk for the property to face future weather events or future natural disasters.

### Example 11

The method of Example 9, wherein generating the overall roof score is assigned a grade indicative of a condition of the property to face future weather events or natural disasters.

### Example 12

The method of Example 9, wherein the roof risk factors comprise roof damage, roof patching, roof wear & tear, roof rust, roof tree overhang, roof ponding, roof staining, and roof debris.

### Example 13

The method of Example 9, further comprising: determining a state of each roof risk factor, mapping the state of each roof risk factor an associated weighted state score, summing the weighted state scores to produce a weighted sum of state scores, and using the weighted sum of state scores to determine a roof score.

### Example 14

The method of Example 9, further comprising: determining a confidence level, for an accuracy of a machine learning detection, for each detected roof risk factor; and for each detected roof factor having a confidence level below a pre-selected threshold, performing a secondary manual detection.

### Example 15

The method of Example 9, wherein the machine learning model is trained based on an initial set of labelled image and training updates are provided by monitoring recommendations generated from the overall roof score and the roof risk factors.

### Example 16

A computer implemented property investigation system comprising:

a machine learning system having at least one processor and a machine learning model trained to:

select historical weather data and natural disaster data for a geographic location associated with a property;

select image data available for the property satisfying a set of conditions including the property boundary information, a minimum image quality for imagery data, and a recency range for imagery data;

mask the imagery data using the boundary information to generate masked imagery data;

perform an image analysis of the masked imagery data, via a machine learning model trained to detect a set of roof risk factors of a building structure from imagery data; and

generate an overall roof score based on the historical weather data, the historical natural disaster data, and a weighted distributed of the presence or degree of each roof risk factor from the set of property risk factors.

### Example 17

The system of Example 16, wherein the machine learning system is further trained based on an initial set of labelled images and training updates are provided by monitoring recommendations generated from the overall roof score and the roof risk factors.

### Example 18

The system of Example 16, wherein the machine learning system is further trained based on an initial set of labelled image and training updates based on monitoring claims data associated with property repairs.

### Example 19

The system of Example 16, wherein the machine learning system is further trained based on an initial set of labelled image and training updates based on monitoring manual quality assurance corrections for detected roof risk factors below a confidence level.

### Example 20

The system of Example 16, wherein the machine learning system is further trained to automatically generate property recommendations based on the overall roof score and training instances associated with sample recommendations.

### Example Set II

### Example 1

A computer implemented property investigation method comprising:

determining property boundary information for a property;

selecting image data available for the property;

masking the imagery data using the boundary information to generate masked imagery data;

performing an image analysis of the masked imagery data, to detect attributes of a property risk factor via a trained machine learning model;

classifying, based on the detected attributes of the property risk factor, the risk factor into a tier of risk from at least two different tiers of risk;

determining a priority level for monitoring or remediating the risk factor; and

generating a recommendation for the property based on the risk factor.

### Example 2

The method of Example 1, further comprising accessing historical weather and natural disaster data for a location of the property and generating the recommendation for the risk factor includes basing the recommendation on a combination of factors including the historical weather data, historical natural disasters, and the risk factor.

### Example 3

The method of Example 2, wherein the tier of risk of the detected property risk factor is utilized to generate a recommendation for a risk of roof damage of a building structure to at least one of a weather event or a natural disaster event.

### Example 4

The method of Example 3, wherein the recommendation displays the risk and a relative risk.

### Example 5

The method of Example 1, wherein tiers of detection includes detecting the presence or absence of a property risk.

### Example 6

The method of Example 1, where the detecting includes detecting a high, medium, and low level of the risk.

### Example 7

The method of Example 1, wherein the property risk factor is a roof risk factor selected from the group consisting of roof damage, roof patching, roof wear & tear, roof rust, tree overhang, ponding, staining, and roof debris.

### Example 8

The method of Example 1, wherein the property risk factor is selected from the group consisting of a pool risk factor, a work coating risk factor, a ballast displacement risk factor, a tarp risk factor, an EPDM risk factor, a parapet risk factor, a roof construction risk factor, a building construction risk factor, a yard debris risk factor, a pallet storage risk factor, a propane tank risk factor, an HVAC unit risk factor, an exhaust deposit risk factor, a ridged shingle risk factor, a raised shingle tabs risk factor, a solar panel risk factor, a trampoline risk factor, a playground risk factor, and a deck risk factor.

### Example 9

A computer implemented property investigation method comprising:

determining property boundary information for a property;

selecting image data available for the property;

masking the imagery data using the boundary information to generate masked imagery data;

performing an image analysis of the masked imagery data, to detect a roof risk factor of a building structure via a machine learning model trained to detect the property risk factor from the imagery data;

classifying the detected roof risk factor into a tier of risk from at least two different tiers; and

generating a recommendation based on the tier of risk of the detected roof risk factor.

### Example 10

The method of Example 9, wherein recommendation includes a priority level, based on the tier of risk, for performing a monitoring or repair operation for the property associated with the detected property risk factor.

### Example 11

The method of Example 10, wherein the recommendation is associated with remediating or monitoring a risk of roof damage for at least one of a weather-related event and a natural disaster event.

### Example 12

The method of Example 11, wherein the recommendation displays the risk and a relative risk.

### Example 13

The method of Example 10, wherein classifying the tiers of risk includes detecting the presence or absence of a roof risk.

### Example 14

The method of Example 9, where the classifying includes detecting a high, medium, and low level of the roof risk.

### Example 15

The method of Example 9, wherein the roof risk factor is a roof risk factor selected from the group consisting of roof damage, roof patching, roof wear & tear, roof rust, tree overhang, ponding, staining, and roof debris.

### Example 16

The method of Example 9, wherein the roof risk factor is selected from the group consisting of a worn coating risk factor, a tarp risk factor, an EPDM risk factor, a parapet risk factor, a roof construction risk factor, an exhaust deposit risk factor, a ridged shingling risk factor, a raised shingle tabs risk factor, and a solar panel risk factor.

### Example 17

A computer implemented property investigation system comprising:

a machine learning system having at least one processor and a machine learning model trained to:

perform an image analysis of masked imagery data, to detect a roof risk factor of a building structure via a machine learning model trained to detect attributes of a roof risk factor from the imagery data;

classify the roof risk factor into a tier of risk from at least two different tiers; and

generate a recommendation based on the tier of risk of the roof risk factor.

### Example 18

The method of Example 17, wherein the tier of risk of the roof risk factor is utilized to generate a recommendation for a risk of future roof damage for at least one of a weather-related event or a natural disaster event.

### Example 19

The method of Example 18, further comprising analyzing data indicative of historical weather-related events and natural disaster events and determining a risk based on the historical data and the roof risk factor.

### Example 20

The method of Example 18, wherein the roof risk factor is a roof risk factor selected from the group consisting of roof damage, roof patching, roof wear & tear, roof rust, tree overhang, ponding, staining, and roof debris.

### Example Set III

### Example 1

A computer implemented property investigation system method comprising:

accessing, based on an address of a property, at least one source of geographical coordinate information for a property from a plurality of geographical coordinate information sources in a sequence proceeding from a primary source of geographical coordinate information to at least one secondary source of geographical coordinate information;

determining property boundary information for the property from the geographical coordinate information and identifying an associated building structure footprint;

determining a recency range for selecting imagery data for the property;

selecting imagery data available for the property from a plurality of sources of imagery data in a sequence chosen to select a highest quality available image source having at least a minimum image quality for the imagery data and satisfying the recency range;

masking the selected imagery data using the boundary information and the building structure footprint to generate masked imagery data within the recency range;

performing an image analysis of the masked imagery data, via a machine learning model trained to detect attributes of a set of property risk factors from imagery data; and

determining a presence or a degree of each property risk factor of the set of property risk factors from the image analysis.

### Example 2

The method of Example 1, wherein determining property boundary information comprises utilizing the property address to obtain property boundary coordinates and a structure footprint for the property.

### Example 3

The method of Example 1, further comprising generating a recommendation for an action associated with monitoring or remediating the property risk.

### Example 4

The method of Example 1, wherein the property score is a roof score.

### Example 5

The method of Example 4 wherein the property risk factors that are detected include a set of roof risk factors comprising at least one: roof damage, roof patching, roof wear & tear, roof rust, roof tree overhang, roof ponding, roof staining, and roof debris.

### Example 6

The method of Example 5, further comprising: determining a state of each roof risk factor, mapping the state of each roof risk factor an associated weighted state score, summing the weighted state scores to produce a weighted sum of state scores, and using the weighted sum of state scores to determine a roof score.

### Example 7

The method of Example 5, further comprising: determining a confidence level, for an accuracy of a machine learning detection, for each detected roof risk factor; and for each detected roof factor having a confidence level below a pre-selected threshold, performing a secondary manual detection.

### Example 8

The method of Example 7, wherein secondary manual detection is performed and detected roof risk factor is accepted if a consensus is reached with the secondary manual detection.

### Example 9

A computer implemented property investigation system comprising:

accessing, based on an address of a property, at least one source of geographical coordinate information for a property from a plurality of geographical coordinate information sources in a sequence proceeding from a primary source of geographical coordinate information to at least one secondary source of geographical coordinate information;

determining property boundary information for the property from the geographical coordinate information and identifying an associated building structure footprint;

determining a recency range for selecting imagery data for the property;

selecting imagery data available for the property from a plurality of sources of imagery data in a sequence chosen to select a highest quality available image source having at least a minimum image quality for the imagery data and satisfying the recency range;

masking the selected imagery data using the boundary information and the property footprint to generate masked imagery data within the recency range;

selecting historical weather data and natural disaster data for a geographic location associated with the property;

performing an image analysis of the masked imagery data, via a machine learning model trained to detect a set of roof risk factors from imagery data.

detecting a presence or a degree of each roof risk factor of the set of roof risk factors from the image analysis;

generating an overall roof score based on the historical weather data, the historical natural disaster data, and a weighted distributed of the presence or degree of each roof risk factor from the set of property risk factors.

### Example 10

The method of Example 9, wherein the overall roof score is assigned a grade.

### Example 11

The method of Example 9, wherein the grade is indicative of recommended actions including monitoring and remediating at least one roof condition.

### Example 12

The method of Example 9, wherein the roof risk factors that are detected include a set of roof risk factors comprising at least one of: roof damage, roof patching, roof wear & tear, roof rust, roof tree overhang, roof ponding, roof staining, and roof debris.

### Example 13

The method of Example 12, further comprising: determining a state of each roof risk factor, mapping the state of each roof risk factor an associated weighted state score, summing the weighted state scores to produce a weighted sum of state scores, and using the weighted sum of state scores to determine a roof score.

### Example 14

The method of Example 12, further comprising:

determining a confidence level, for an accuracy of a machine learning detection, for each detected roof risk factor; and for each detected roof factor having a confidence level below a pre-selected threshold, performing a secondary manual detection.

### Example 15

The method of Example 9, wherein the roof score is calibrated, based on historical data for comparable properties, to be predictive of a risk of future roof damage.

### Example 16

The method of Example 9, wherein the roof score is calibrated, based on historical data for comparable properties, to be predictive of a priority for performing at least one action selected from the group consisting of monitoring a roof status, performing a roof repair on a non-urgent basis, and performing a roof repair on an urgent basis.

### Example 17

A computer implemented property investigation system comprising:

a machine learning system having at least one processor and a machine learning model trained to:

select historical weather data and natural disaster data for a geographic location associated with the property;

access, based on an address of a property, at least one source of geographical coordinate information for a property from a plurality of geographical coordinate information sources in a sequence proceeding from a primary source of geographical coordinate information to at least one secondary source of geographical coordinate information;

determine property boundary information for the property from the geographical coordinate information and identifying an associated building structure footprint;

determine a recency range for selecting imagery data for the property;

select imagery data available for the property from a plurality of sources of imagery data in a sequence chosen to select a highest quality available image source having at least a minimum image quality for the imagery data and satisfying the recency range;

mask the selected imagery data using the boundary information and the building structure footprint to generate masked imagery data within the recency range;

perform an image analysis of the masked imagery data, via a machine learning model trained to detect a set of roof risk factors from imagery data.

detect a presence or a degree of each roof risk factor of the set of roof risk factors from the image analysis; and

generate an overall roof score based on the historical weather data, the historical natural disaster data, and a weighted distributed of the presence or degree of each roof risk factor from the set of property risk factors.

### Example 18

The system of Example 17, wherein the machine learning system is further trained based on an initial set of labelled images and training updates are provided by monitoring recommendations generated from the overall roof score and the roof risk factors.

### Example 19

The system of Example 17, wherein the machine learning system is further trained based on an initial set of labelled image and training updates based on monitoring claims data associated with property repairs.

### Example 20

The system of Example 17, wherein the machine learning system is further trained based on an initial set of labelled image and training updates based on monitoring manual quality assurance corrections for detected roof risk factors below a confidence level.

### Example 21

A computer implemented property investigation method comprising:

determining property boundary information for a property;

selecting image data available for the property satisfying a set of conditions including the property boundary information, a minimum image quality for imagery data, and a recency range for imagery data;

masking the imagery data using the boundary information to generate masked imagery data;

performing an image analysis of the masked imagery data, via a machine learning model trained to detect a set of roof risk factors from imagery data;

detecting a presence or a degree of each property risk factor of the set of property risk factors from the image analysis;

generating a confidence level for each detected property risk factor;

approving each detected presence or degree of each property risk factor having a confidence level exceeding a pre-selected threshold to generate a first set of approved detections;

performing an auxiliary approval process for each property risk factor having a confidence level not exceeding the pre-selected threshold by performing at least one manual quality assurance check to generate a second set of approved detections; and

generating at least one property grade based on the first set of approved detections and the second set of approved detections.

### Example 22

The method of Example 21, wherein the at least one property grade is further based on historical data on weather related events and natural disasters for the location of the property such that the at least one property grade is indicative of property risks associated with a condition of the property for future weather related events and natural disasters.

### Example Set IV

### Example 1

A computer implemented property investigation system method comprising:

determining property boundary information for a property;

accessing historical weather and natural disaster information for a location of the property;

selecting image data available for the property satisfying a set of conditions including the property boundary information, a minimum image quality for imagery data, and a recency range for imagery data;

masking the imagery data using the boundary information to generate masked imagery data;

performing an image analysis of the masked imagery data, via a machine learning model trained to detect attributes of a set of roof risk factors from imagery data;

detecting a presence or a degree of each property risk factor of the set of property risk factors from the image analysis;

generating an overall roof score based on weighted distributed of the presence or degree of each property risk factor from the set of property risk factors and historical weather and natural disaster events for the location of the property, wherein the weighting of the roof score is selected to be predictive of a risk of roof damage; and

generating a recommendation that includes the overall roof score and suggested actions for monitoring or remediating a roof risk.

### Example 2

The method of Example 1, wherein the recommendation is based on a sample set of recommendations chosen for comparable overall roof risk scores and detected risk factors.

### Example 3

The method of Example 2, wherein a user interface is provided for user to select recommendations for properties and the user-selected recommendations are monitored to generate the sample set.

### Example 4

The method of Example 3, wherein at least one default recommendation is suggested based on the sample set.

### Example 5

The method of Example 3, wherein a risk priority level is assigned to specific overall roof scores and individual roof factor scores for roof conditions having a low risk priority level and at least one default recommendation is generated for automatically responding to comparable combinations of overall roof scores and individual roof factor scores.

### Example 6

The method of Example 3, wherein a risk priority level is assigned to specific overall roof scores and individual roof factor scores for roof conditions having selected risk priority level and at least one editable default recommendation is generated for responding to comparable combinations of overall roof scores and individual roof factor scores.

### Example 7

The method of Example 1, wherein the recommendation is provided in property profile including images of a building structure.

### Example 8

The method of Example 1, further comprising providing the recommendation in user interface providing features for an end user to select from a set of default recommendations and customize recommendations; monitoring the end user's selections and customizations; and utilizing the selections and customizations as training data for the generation of default recommendations.

### Example 9

A computer implemented property investigation system comprising:

a machine learning system having at least one processor and a machine learning model trained to:

determine property boundary information for a property;

access historical weather and natural disaster information for a location of the property;

select image data available for the property satisfying a set of conditions including the property boundary information, a minimum image quality for imagery data, and a recency range for imagery data;

mask the imagery data using the boundary information to generate masked imagery data;

perform an image analysis of the masked imagery data, via a machine learning model trained to detect attributes of a set of roof risk factors from imagery data;

detect a presence or a degree of each property risk factor of the set of property risk factors from the image analysis;

generate an overall roof score based on weighted distributed of the presence or degree of each property risk factor from the set of property risk factors and historical weather and natural disaster events for the location of the property, wherein the weighting of the roof score is selected to be predictive of a risk of roof damage; and

generate a recommendation that includes the overall roof score and suggested actions for monitoring or remediating a roof risk.

### Example 10

The system of Example 9, wherein the recommendation is based on a sample set of recommendations chosen for comparable overall roof risk scores and detected risk factors.

### Example 11

The system of Example 10, wherein a user interface is provided for user to select recommendations for properties and the user-selected recommendations are monitored to generate the sample set.

### Example 12

The system of Example 11, wherein at least one default recommendation is suggested based on the sample set.

### Example 13

The system of Example 11, wherein a risk priority level is assigned to specific overall roof scores and individual roof factor scores for roof conditions having a low risk priority level and at least one default recommendation is generated for automatically responding to comparable combinations of overall roof scores and individual roof factor scores.

### Example 14

The system of Example 11, wherein a risk priority level is assigned to specific overall roof scores and individual roof factor scores for roof conditions having selected risk priority level and at least one editable default recommendation is generated for responding to comparable combinations of overall roof scores and individual roof factor scores.

### Example 15

The system of Example 9, wherein the recommendation is provided in property profile including images of a building structure.

### Example 16

The system of Example 9, further comprising providing the recommendation in user interface providing features for an end user to select from a set of default recommendations and customize recommendations; monitoring the end user's selections and customizations; and utilizing the selections and customizations as training data for the generation of default recommendations.

### Example Set V

### Example 1

A computer implemented property investigation system method comprising:

accessing at least one source of property image data from the group consisting of satellite images, aerial images, street view images, and drone images;

accessing at least one source of historical property data;

aggregating, for a particular property, at least one source of property image data and at least one source of historical property data; and

analyzing the aggregated data and generating a property grade.

### Example 2

The method of Example 1, wherein the analyzing includes identifying potential property hazards or risks based on the property image data, scoring the property hazards or risks, and generate a grade.

### Example 3

The method of Example 1, further comprising training an artificial intelligence to analyze the aggregated and generate a property grade.

### Example 4

The method of Example 1, wherein the property image data includes satellite images, aerial images, and street views and the method further comprises generating a drone flight recommendation based on whether or not an analysis of the satellite images, aerial images, and street views results in a preliminary assessment of a potential property damage, hazard, or risk.

### Example 5

The method of Example 1, further comprising generating reports for at least one of insurance claims, insurance underwriting, and construction.

### Example 6

The method of Example 1 wherein the property grade is a roof grade.

### Example 7

The method of Example 6, wherein the roof grade is indicative of a condition of a roof.

### Example 8

The method of Example 1, further comprising detecting a change in a building or roof.

### Example 9

The method of Example 8, wherein the detected change is a building or roof modification.

### Example 10

The method of Example 8, wherein the detected change is a destruction of a building or a roof.

### Example 11

The method Example claim 1, wherein historical insurance claims data is used to adapt a scoring technique to generate the property grade.

### Example 12

A method of property investigation, comprising:

accessing image data for a property;

accessing historical data for the property;

analyzing, via an artificial intelligence engine trained to detect property damage, hazards, or risks, the accessed image data and generating scores for the detected property damage, hazards, or risks;

generating a property profile including at least one property grade for the property based on a standardized grading protocol utilizing the generated scores and the historical data for the property.

### Example 13

The method of Example 12, further comprising providing at least one property recommendation for the property grade in the property profile.

### Example 14

The method of Example 12, wherein the property grade comprises a roof grade.

### Example 15

The method of Example 12, wherein the artificial intelligence engine generates a detection of changes to a roof or a building including a detection of a damaged or destroyed roof.

### Example 16

The method of Example 12, wherein the artificial intelligence engine generates a detection of changes to a roof or a building including a detection of a damaged or destroyed building.

### Example 17

The method of Example 12, wherein the artificial intelligence engine generates a detection of changes to a roof or a building including a detection of a modification of a roof over a period of time.

### Example 18

The method of Example 12, wherein the artificial intelligence engine generates a detection of changes to a roof or a building including a detection of a modification of a building over a period of time.

### Example 19

The method of Example 12, wherein the method further comprises generating scores for the detected property damage, hazards, or risks based at least in part on feedback from historical insurance claims data.

### Example 20

The method of Example 19, wherein the artificial intelligence engine collects insurance claims data for at least a sample of previously scored properties or roofs and a scoring algorithm is adapted based on feedback from the collected insurance claims data.

### Example 21

A method of property investigation, comprising:

accessing image data for a property;

accessing historical data for the property;

analyzing, via an artificial intelligence engine trained to detect property damage, hazards, or risks, the accessed image data and generating scores for the detected property damage, hazards, or risks;

generating an insurance or underwriting report including at least one property grade for the property based on a standardized grading protocol utilizing the generated scores and the historical data for the property.

### Example 22

A computer implemented property investigation method, comprising:

accessing images of a property;

analyzing, via a computing device, the accessed images and determining indications of property damage, hazards, or risks; and

grading the property according to a standardized grading system and the determined indications of property damage, hazards, or risks.

### Example 23

A method of property investigation, comprising:

accessing image data of a property for a first time-period;

accessing historical data for the property for the first time-period;

analyzing, via an artificial intelligence engine trained to detect property damage, hazards, or risks, the accessed image data and generating scores in the first time-period for the detected property damage, hazards, or risks;

accessing image data of the property for a second time-period;

accessing historical data for the property in the second time-period;

analyzing, via an artificial intelligence engine trained to detect property damage, hazards, or risks, the accessed image data and generating scores in the second time-period for the detected property damage, hazards, or risks;

comparing the scores for the first time-period and the second time-period to detect changes in a roof condition or a building condition.

### ALTERNATE EMBODIMENTS

The disclosed technologies can take the form of an entirely hardware implementation, an entirely software implementation or an implementation containing both software and hardware elements. In some implementations, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies not be limited by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A computer implemented property structure evaluation method comprising:
accessing an image of a property structure;
analyzing the image to generate a plurality of attributes predictive of a loss risk for the property structure;
forming, based on an aggregation of the plurality of attributes predictive of a loss risk, a signal indicative of a loss risk for the property structure.

2. The method of claim 1, wherein the analyzing comprises utilizing a trained machine learning model to analyze the image.

3. The method of claim 1, wherein the analyzing comprises utilizing a human evaluator to analyze the image.

4. The method of claim 1, wherein the analyzing comprises utilizing a combination of human evaluation and a trained machine learning model to analyze the image.

5. The method of claim 1, wherein the analyzing comprises generating an annotation of the image that includes fields that are filled out for each of the plurality of attributes.

6. The method of claim 1, wherein the signal comprises a numerical or graded score for the loss risk.

7. The method of claim 1, wherein the signal comprises a recommendation for the loss risk.

8. The method of claim 1, wherein the method comprises generating a user interface to display information associated with the loss risk for the property structure based on the signal indicative of a loss risk.

9. The method of claim 1, wherein the image comprises an image of a roof of a property structure, plurality of attributes comprises a plurality of roof risk attributes predictive of a loss risk for the roof, and the signal is indicative of a loss risk for the roof of the property structure.

10. A computer implemented property investigation system method comprising:
accessing at least one source of property structure image data from the group consisting of satellite images, aerial images, street view images, and drone images;
accessing at least one source of historical property structure data;
aggregating, for a particular property, at least one source of property structure image data and at least one source of historical property structure data; and
analyzing the aggregated data and generating a property structure grade.

11. The method of claim 10, wherein the analyzing includes identifying potential property structure hazards or risks based on the property image data, scoring the property hazards or risks, and generate a grade.

12. The method of claim 10, further comprising training an artificial intelligence to analyze the aggregated and generate a property structure grade.

13. The method of claim 10, wherein the property structure image data includes satellite images, aerial images, and street views and the method further comprises generating a drone flight recommendation based on whether or not an analysis of the satellite images, aerial images, and street views results in a preliminary assessment of a potential property structure damage, hazard, or risk.

14. The method of claim 10, further comprising generating reports for at least one of insurance claims, insurance underwriting, and construction.

15. The method of claim 10 wherein the property structure grade is a roof grade.

16. The method of claim 15, wherein the roof grade is indicative of a condition of a roof.

17. The method of claim 10, further comprising detecting a change in a building structure or roof.

18. The method of claim 17, wherein the detected change is a building structure or roof modification.

19. The method of claim 17, wherein the detected change is a destruction of a building structure or a roof.

20. The method of claim 10, wherein historical insurance claims data is used to adapt a scoring technique to generate the property structure grade.

21. A method of property investigation, comprising:
accessing image data for a property structure;
accessing historical data for the property structure;
analyzing, via an artificial intelligence engine trained to detect property structure damage, hazards, or risks, the accessed image data and generating scores for the detected property structure damage, hazards, or risks;
generating a property structure profile including at least one property structure grade for the property structure based on a standardized grading protocol utilizing the generated scores and the historical data for the property structure.

22. The method of claim 21, further comprising providing at least one property structure recommendation for the property grade in the property profile.

23. The method of claim 21, wherein the property structure grade comprises a roof grade.

24. The method of claim 21, wherein the artificial intelligence engine generates a detection of changes to a roof or a building structure including a detection of a damaged or destroyed roof.

25. The method of claim 21, wherein the artificial intelligence engine generates a detection of changes to a roof or a building structure including a detection of a damaged or destroyed building structure.

26. The method of claim 21, wherein the artificial intelligence engine generates a detection of changes to a roof or a building including a detection of a modification of a roof over a period of time.

27. The method of claim 21, wherein the artificial intelligence engine generates a detection of changes to a roof or a building structure including a detection of a modification of a building structure over a period of time.

28. The method of claim 21, wherein the method further comprises generating scores for the detected property structure damage, hazards, or risks based at least in part on feedback from historical insurance claims data.

29. The method of claim 28, wherein the artificial intelligence engine collects insurance claims data for at least a sample of previously scored property structure or roofs and a scoring algorithm is adapted based on feedback from the collected insurance claims data.

30. The method of claim 21, further comprising:
generating an insurance or underwriting report including at least one property grade for the property structure based on a standardized grading protocol utilizing the generated scores and the historical data for the property.

31. A computer implemented property investigation method, comprising:
accessing images of a property structure;
analyzing, via a computing device, the accessed images and determining indications of property structure damage, hazards, or risks; and
grading the property according to a standardized grading system and the determined indications of property structure damage, hazards, or risks.

32. A method of property investigation, comprising:
accessing image data of a property structure for a first time-period;
accessing historical data for the property structure for the first time-period;
analyzing, via an artificial intelligence engine trained to detect property damage, hazards, or risks, the accessed image data and generating scores in the first time-period for the detected property damage, hazards, or risks;
accessing image data of the property structure for a second time-period;
accessing historical data for the property structure in the second time-period;
analyzing, via an artificial intelligence engine trained to detect property structure damage, hazards, or risks, the accessed image data and generating scores in the second time-period for the detected property structure damage, hazards, or risks;
comparing the scores for the first time-period and the second time-period to detect changes in a roof condition or a building condition.
